(19) United States
(12) Patent Application Publication
(10) Pub. No.: US 2005/0265905 A1
(43) Pub. Date: Dec. 1, 2005

(54) Multifunctional multireactor chemical synthesis instrument

(75) Inventor: Li Young, Township of Bridgewater, NJ (US)

Correspondence Address: Kenneth P. Glynn, 24 Mine Street, Flemington, NJ, 08822, US

(73) Assignee: Akribio Corp.

(21) Appl. No.: 11/058,528

(22) Filed: Feb. 15, 2005

Related U.S. Application Data
(63) Continuation of application No. 10/827,754, filed on Apr. 20, 2004.

(51) Int. Cl. B32B 5/02

(52) U.S. Cl. 422/129; 376/282

(57) ABSTRACT

A stand alone instrument for enhancing chemical and physical reactions on the “bench” level by providing a single instrument capability of performing a variety of functions on a plurality of reaction vessels at the same time (in parallel), includes heating, cooling and five other functional capabilities, and more particularly to such instruments that provide the matrix of plural functions and plural reaction vessels, with the further ability of providing real time energy balance data on each reactor. Thus, the instruments provide for any or all of heating, cooling, reflux, inert gas blanketing, vacuuming, stirring and evaporation at each reactor. (The words “reactor”, “microreactor”, “reaction vessel” and “vessel” are used interchangeably herein, and generally refer to bench scale flasks, beakers and other reactors used by bench chemists, biochemists, physicists, biologists, research doctors, and the like.) In some embodiments, the instruments include cooling units which uniquely rely upon phase change coolant injections. In other embodiments, the instruments include cofinger stoppers, described below. The instruments may include both the phase change coolant systems and the cofinger stopper arrangements.

### REFERENCES TO RELATED APPLICATIONS

This application is a continuation-in-part of copending U.S. Pat. application Ser. No. 10/827,754, filed on Apr. 20, 2004 and entitled “Multiport Cofinger Microreactor Stopper and Device” by the same inventor herein and of common ownership.

### BACKGROUND OF THE INVENTION

1. Field of the Invention

The present invention is directed to single instruments for performing a variety of functions on a plurality of reaction vessels at the same time (in parallel), that includes heating, cooling and up to five other functional capabilities, and more particularly to such instruments with cooling units that may uniquely rely upon phase change coolant injection. Further, the instruments may include unique cofinger microreactor stoppers for the vessels to enhance efficiencies and to provide many different input and output ports without interference with one another. The instruments also include preprogrammable features and subsystems.

2. Information Disclosure Statement

The following patents are representative of prior art related to various types of heated/cooled reaction vessels:

U.S. Pat. No. 2,472,362 to Herbert L Barnebey et al. describes a method of successively heating and cooling the contents of a vessel by means of a fluid medium,. the steps of confining a body of vaporizable fluid in a hermetically sealed space about the bottom and sides of a vessel to be heated defined by the vessel wall and an auxiliary condensing surface, maintaining a portion of said fluid body in the liquid state as a pool contacting the bottom of said vessel, first applying extraneous heat to boil the liquid and heat the vessel and its contents by exchange of heat through the vessel walls from the hot liquid and condensing vapors, then ceasing to apply extraneous heat to the liquid, and finally extraneously cooling said auxiliary condensing surface causing the vessel and its contents to cool by boiling the liquid pool in contact with said vessel bottom, and condensing the resulting vapor on said surface.

U.S. Pat. No. 2,739,221 to G. H. Morey describes a vessel heater as recited in claim 2 wherein said means includes a first valve communicating with a supply of non-inflammable and non-combustion-supporting fluid in its gaseous phase to regulate admission of a quantity of fluid to blanket said heating element and thereby preclude ignition of combustible products adjacent said heating element, and a second valve communicating with a supply of non-inflammable and non-combustion- supporting fluid in its liquid phase to regulate admission of a quantity of fluid to effect rapid cooling of the vessel.

U.S. Pat. No. 2,894,881 to Clinton M. Wolston, Jr. et al. describes a laboratory distillation testing apparatus having a condenser tank, a flask, a flask supporting means, a heating means, a condenser tube passing through the said tank, and a light diffusing panel, the improvements which comprise a recess in said condenser tank, a shield means disposed within said recess, adjustable shelf means carried by said shield means for supporting said flask, conduit means below said tank, and solenoid valve means on said conduit means, the discharge end of said conduit means projecting forwardly of the rear wall of said recess below said condenser tube inlet and arranged to discharge forwardly and downwardly towards said shelf means.

U.S. Pat. No. 3,143,167 to A. Vieth describes a temperature controlled enclosure comprising a first metal wall surrounding the enclosure space, a heating means in thermal contact with said first wall for raising the temperature of the enclosure, a second metal wall surrounding the heating means, cooling means in thermal contact with said second wall for lowering the temperature of the enclosure, a first temperature-sensitive element in thermal contact with said first metal wall, a second temperature-sensitive element in thermal contact with said second metal wall, and a control circuit connected between said elements and said heating and cooling means for energizing the heating and cooling means selectively to produce a desired temperature within the enclosure, said control circuit including a bridge, an amplifier, and a switching means for connecting the heating means to a source of power when said first temperature-sensitive element is connected to the bridge and for activating the cooling means when said second temperature-sensitive element is connected to the bridge.

U.S. Pat. No. 3,239,432 to Joseph C. Rhodes et al. describes an apparatus for controlling the operation of a first distillation column and for determining the distillation properties of a product sample from said first column which apparatus comprises: means for withdrawing a product sample containing a mixture of liquids having different boiling points from said first column; a test column member; a plurality of liquid-retaining trays spaced apart vertically within said test column; a liquid sample container positioned below said test column and in flow communication with the bottom-most portion of said test column; means for receiving said withdrawn product sample and introducing a known amount of said product sample into said container; means for vaporizing liquid sample introduced into said container; vapor riser means for passing vapors from the lower portion of said test column upwardly through said test column to intimately contact liquid retained on said trays; condensing means communicating with the upper end of said test column to condense all the vapors rising from the upper-most of said trays; means for returning the resulting condensate to the upper-most of said trays; means for maintaining the test column pressure at a substantially constant pressure during a run; means for maintaining a pre-selected level of liquid on said trays; temperature sensing means to sense the temperatures and produce a temperature signal indicative thereof of equilibrium vapors above the trays in said test column; means for receiving said temperature signal and correlating the sensed temperatures with the distillation properties of a known product sample of approximately the same composition as said sample being run and produced an output signal relative to said correlation; and means for receiving said output signal and adjusting the control parameters of the first column in accordance with said output signal.

U.S. Pat. No. 3,473,387 to Charles Meriam describes an inclined-manometer-type of fluid characteristic measuring instrument which is responsive to pressure sensing for directly reading volume, weight or velocity of flow, or differential pressure across a flow measuring orifice, nozzle, venturi or laminar flow element or for directly reading static head, velocity head or total head fluid pressure. Adjustments are provided for correcting the instrument reading measurements for variations in fluid measurement conditions, including temperature of, density of, viscosity of, barometric pressure on, humidity of, mixture of fluids in, etc. of the fluid being measured; temperature, etc. of the manometer liquid; etc.

U.S. Pat. No. 3,479,252 to Kurt Anders Holm et al. describes an invention which is concerned with an apparatus for degreasing articles by means of a boiling solvent or vapor originating therefrom. The apparatus has double walls, and cooling means which are provided between said double walls. The cooling means comprise water spraying means, and means for passing ventilation air through the space defined by said double walls. Consequently, the ventilation air has the double function of withdrawing solvent vapor and cooling the wall of the apparatus.

U.S. Pat. No. 4,019,365 to Lecon Woo describes a thermomechanical analyzer adapted to measure stress or strain in a sample material by the use of a flat, passive spring, having a known modulus of elasticity, in conjunction with an axially displaceable shaft which mechanically links the spring and the sample together. The linkage is such that the sample under test and the spring are mechanically connected in parallel, i.e., each undergo equal displacement. A transducer senses axial displacement of the shaft such that the magnitude of the shaft displacement is related to the stress in the sample. The sample may be subjected to temperature variations during the test cycle.

U.S. Pat. No. 4,030,314 to John Frederick Strehler describes preservation of biological materials accomplished by apparatus and a process with and by which the material is cooled at a substantially linear rate to approximately freezing temperature, changed from the liquid to the solid phase at relatively constant temperature, and cooled at a substantially linear rate to and end temperature. The environment surrounding the material is rapidly chilled when the material reaches freezing temperature or a temperature minimally warmer than freezing temperature in the liquid phase to initiate phase change with minimal risk of super cooling the material, and is then warmed to freezing temperature or a temperature minimally cooler than freezing temperature to minimize temperature drop in the material upon completion of phase change. The apparatus contemplates, among other things, preselection of cooling rates, duration of phase change, and the end temperature.

U.S. Pat. No. 4,043,762 to George Milton Olds describes a coupling means for test tubes and the like, the coupling means enabling the coupling of test tubes to other objects or devices for various purposes, as for example, support purposes. In one embodiment of the invention, the coupling means is comprised of a flexible, resilient, tubular body portion which is open at each end and which is adapted to be slideably circumimposed on a portion of the periphery of a conventional tubular test tube of the type that is closed at one end, the coupling means also including a pair of cirumferentially spaced, -flexible, resilient and integral flange portions which project longitudinally outwardly from one end of the tubular body portion and which define openings adjacent the free ends thereof adapted to receive a cooperating member such as the stem of a conventional funnel, a support rod, a thermometer or other object to which it is desired to couple a test tube. In another embodiment of the invention, the coupling means is formed integrally with the body portion of a test tube.

U.S. Pat. No. 4,117,881 to Thomas E. Williams et al. describes blood cells, blood marrow, and other similar biological tissue that is frozen while in a polyethylene bag placed in abutting relationship against opposed walls of a pair of heaters. The bag and tissue are cooled with refrigeratoring gas at a time programmed rate at least equal to the maximum cooling rate needed at any time during the freezing process. The temperature of the bag, and hence of the tissue, is compared with a time programmed desired value for the tissue temperature to derive an error indication. The heater is activated in response to the error indication so that the temperature of the tissue follows the desired value for the time programmed tissue temperature. The tissue is heated to compensate for excessive cooling of the tissue as a result of the cooling by the refrigerating gas. In response to the error signal, the heater is deactivated while the latent heat of fusion is being removed from the tissue while the tissue is changing phase from liquid to solid.

U.S. Pat. No. 4,276,264 to Jury V. Redikultsev et al. describes a device for sterilizing water-containing liquid media by steam which comprises a sterilizing vessel with inlet and outlet connections for processed liquid media. A heater is provided in the lower portion of the vessel, while a condenser is arranged in the upper portion thereof. The vessel also houses a coaxially mounted steam-transfer unit representing gas-lift tube with a diffuser disposed over the heater.

U.S. Pat. No. 4,346,754 to Leland A. Imig et al. describes a heating and cooling apparatus capable of cyclic heating and cooling of a test specimen undergoing fatigue testing. Cryogenic fluid is passed through a block 10 clamped to the specimen 11 to cool the block and the specimen. Heating cartridges 13 penetrate the block 10 to heat the block and the specimen 11 to very hot temperatures. Control apparatus 36 and 46 is provided to alternately activate the cooling and heating modes to effect cyclic heating and cooling between very hot and very cold temperatures. The block 10 is constructed of minimal mass to fascilitate the rapid temperature change thereof U.S. Pat. No. 4,480,682 to Hiroshi Kaneta et al. describes an apparatus for freezing fertilized ova, spermatozoa or the like has a heat transfer bottom board block formed at the lower end of a heat insulating peripheral wall with a lower refrigerant passage capable of flowing refrigerant. A bottom board temperature sensor is attached to the bottom board block, an upper heat transfer block is placed on the bottom board block through a heat insulating joint member, formed with an upper refrigerant passage for flowing the refrigerant. A temperature control heater, an upper block temperature sensor, a plurality of erecting tube charging spaces of tubes opened at the top thereof with the bottom goard block as a bottom member are disposed between the peripheral wall and the upper block in such a manner that the tubes erected and charged into the spaces are cooled at the lower ends thereof by said bottom board block and at the upper part containing articles to be frozen such as fertilized ova, spermatozoa or the like are contained in buffer solution in said tubes. Thus, the buffer solutions in the tubes can be controlled to be cooled at the buffer solution of the lower noncontaining part by the bottom board block and the buffer solution of the containing part above the buffer solution of the lower noncontaining part by the upper block.

U.S. Pat. No. 4,489,569 to Helmuth Sitte describes a cooling apparatus utilizing liquid nitrogen for cooling specimens to temperatures in the range from −100° C. to −195° C. in propane, halogenated hydrocarbons, isopentane, or other cooling media. Freezing of the cooling media is avoided by means of an arrangement wherein the liquid nitrogen cools the cooling-bath container and/or the liquifier only initially, but after the desired cooling-bath temperature has been reached, the liquid nitrogen level is lowered to below the height of a protective shell which results in further cooling being only indirect, via solid/solid contacts and via the gas phase. A constant cooling-bath temperature is ensured by means of a thermostatic temperature-control system while trouble-free standby operation is ensured by means of an automatic system for replenishing liquid nitrogen, and by a system for controlling the level of liquid nitrogen. Safe disposal of the cooling media which may be combustible and/or toxic is provided for.

U.S. Pat. No. 4,502,531 to Peter Petersen describes an invention that provides an apparatus and method or heating a vessel having a vessel bottom and at least one vessel side wall. The invention includes a furnace housing which is adapted to contain the vessel and which has a housing bottom and at least one housing side wall. A heater mechanism, located at the housing bottom and at the housing side wall, heats the vessel and is adapted to contact selected portions of the vessel bottom and vessel side wall. Thermal insulation is disposed about the housing for reducing heat loss therefrom, and an extendable temperature sensor is adapted to contact the vessel and monitor the temperature thereof.

U.S. Pat. No. 4,548,259 to Sadao Tezuka describes a flow cell for containing sample solutions is surrounded by an electric heater which is then surrounded by an isothermal frame having a large heat capacity, and a Peltier element serving as a cooling source is coupled with the isothermal frame. A heat delaying plate is arranged between the flowcell and heater and a temperature sensor is arranged between the flowcell and the heat delaying plate. The Peltier element is controlled in such a manner that the temperature of the isothermal frame is maintained substantially at a constant temperature lower than a predetermined temperature at which the sample solution is to be kept. The heater is controlled in accordance with a difference between the temperature of the sample solution and the predetermined temperature.

U.S. Pat. No. 4,563,883 to Hellmuth Sitte describes a device for immersing a specimen into a cryogenic cooling liquid comprising an injector for carrying a specimen, means for accelerating the injector to a predetermined velocity vertically into the liquid, and means for rotating the injector, before the vertical movement ends, or at moment it ends, to promote heat transfer from the specimen. Various means for effecting rotation of the injector are described.

U.S. Pat. No. 4,578,963 to Hellmuth Sitte describes an apparatus for the cryofixation of specimens, comprises a tank adapted to contain a cold gaseous medium having an upper boundary with an atmosphere external to the tank, and cooling means having an upper surface, said cooling means being disposed within the tank. The upper surface is movable between a lower level and an upper level which is below the upper boundary. The upper surface is maintained at the upper level for a period sufficient to permit the application of a specimen to the upper surface, and is then lowered to the tower level.

U.S. Pat. No. 4,667,730 to Georg Zemp describes a temperature regulating apparatus for a laboratory reaction vessel arrangement, which comprises a reaction vessel and a thermal chamber for a fluid heat exchange medium which at least partially surrounds the reaction vessel. A jacketing vessel is provided with at least one inlet aperture for said fluid heat exchange medium and at least partially surrounds the thermal chamber. The at least one inlet aperture is arranged to extend through the jacketing vessel and into the thermal chamber, and a nozzle is arranged in a region of the at least one inlet aperture. This nozzle has an outlet orifice and is arranged in the region of the at least one inlet aperture such that the fluid heat exchange medium flows through the nozzle and out of the outlet orifice and such that the fluid heat exchange medium flowing out of the outlet orifice subsequently flows into said thermal chamber.

U.S. Pat. No. 4,846,257 to Terry A. Wallace et al. describes an apparatus for keeping food hot and/or cold which includes a body of heavily insulated material in which there are serparate recesses for hot food and cold food. The cold food is kept cold by means of an ice compartment located in the bottom recess and an exhaustible refrigeration unit located in the top of that recess. The hot food is kept warm by means of an electrical coil in the bottom of the recess and a solar heating panel in the top.

U.S. Pat. No. 4,966,469 to Douglas S. Fraser et al. describes a positioning device for a temperature sensor in a flask for freeze drying. The device comprises a generally circular plastic stopper having an opening approximately in its center. The stopper is snap-fittingly secured to the top of the flask. A central, annular tube extends through that opening and into the flask. A thermocouple having a generally circular cross section is coiled around and supported by the annular tube so that it is free and is in the center of the flask. The thermocouple is retractable and extensible to permit the use of the thermocouple in flasks of various lengths.

U.S. Pat. No. 5,123,477 to Jonathan M. Tyler describes a thermal reactor, and a method of operating the thermal reactor, in which the thermal reactor includes a chamber which is thermally isolated by refrigerated air circulating in the walls of the chamber, and which holds a tray of sample vials, means for supplying air to the chamber and for exhausting air from the chamber; heaters for heating the air supplied to the chamber; sensors for sensing the temperature of the air supplied to the chamber and of the sample vials, and a computer which pulses the heaters according to the measured temperatures of the vials and the air in the chamber to maintain the temperature of the vials at a desired level.

U.S. Pat No. 5,139,079 to Michael L. Becraft describes a present invention providing for improved performance of a dynamic mechanical analyzer which measures mechanical and rheological properties of a material by reducing thermal lag in the material by modifying the radiative oven thereof to include a convective transfer device.

U.S. Pat. No. 5,154,067 to Takeshi Tomizawa describes a portable cooler for cooling an article by utilizing the endothermic and exothermic phenomenon pertaining to a chemical reaction which is disclosed, in which an adsorbent and a working medium are sealed in a reaction chamber defined between an inner wall and an outer wall, a working medium retaining member which is disposed on the inner wall inside the reaction chamber for holding therein the working medium, the working medium retaining member being spaced from the adsorbent disposed on the outer wall, and a heater is held in contact with the adsorbent for regenerating the same, at least a part of said outer wall constituting a heat radiating portion.

U.S. Pat. No. 5,171,538 to Ewald Tremmel et al. describes a reagent supply system for a medical analytical instrument which includes a reagent space provided on the instrument and reagent vessels which are received in the reagent space. In the reagent space there is provided at least one reagent vessel compartment with a bottom, lateral guide elements, and a top guiding element, as well as a front stop. The instrument contains a fluid communication system for connection with a reagent vessel situated in the reagent vessel compartment. On the end face of the reagent vessel compartment is disposed a hollow needle near the bottom surface thereof and extending in a direction which is parallel to the bottom surface. The reagent vessel has on its front wall facing the end face a pierceable seal with pierceable elastic stopper.

U.S. Pat. No. 5,176,202 to Daniel D. Richard describes a method used in low temperature storage of biological specimens comprising the steps of (a) maintaining a multiplicity of biological specimens within a predetermined low temperature range in a cryogenic storage unit, (b) selecting at least one biological specimen for removal from the storage unit, (c) determining a respective thaw period and thaw rate for the selected specimen, (d) automatically retrieving the selected specimen from the storage unit at removal time in accordance with the respective determined thaw period, and (e) automatically thawing the selected specimen at the respective thaw rate. An associated thawing system comprises a storage unit for maintaining a plurality of biological specimens within a predetermined low temperature range, a plurality of thawing chambers, and a heat exchange assembly for implementing a temperature change in each of the chambers independently of temperature changes in the other chambers. A servomechanism is provided for retrieving selected specimens from the storage unit and transfering the retrieved specimens to respective thawing chambers, while a control unit is operatively connected to the heat exchange assembly and the servomechanism for operating the heat exchange assembly to control rates of temperature changes in the thawing chambers and for activating the servomechanism to transfer the selected specimens from the storage unit to the respective chambers.

U.S. Pat. No. 5,203,203 to William L. Bryan et al. describes an apparatus for measuring in situ the viscosity of a fluid in a sealed container which includes a spherical ball forming an integral package before any fluid is placed within the container. The apparatus further includes a composite ball consisting of a spherical core of one material surrounded by one or more layers of different materials distributed spherically about the core. The container may also be supported by an angular support member which angularly positions the container such that the ball will move within the container through the fluid at specific speed. A sensing device is provided along the wall of the container to measure the speed of the ball wherein the sensing device includes a pair of sensors spaced apart by a known distance to sense when the ball passes by each of the sensors providing a speed which is useful for calculating the viscosity of the fluid.

U.S. Pat. No. 5,337,806 to Josef Trunner describes a bath in which the supply reservoir is arranged for the liquid, in which the reaction flask to be heated or cooled can be immersed. The heating or cooling device is arranged on the bottom of the supply reservoir. The liquid is delivered with an immersion pump through a feed pipe and an opening in the bottom of the bath. The level of the liquid in the bath can be adjusted with the aid of a slider. The liquid flows back into the supply reservoir over an overflow. When the pump is switched off, the liquid in the bath flows independently back into the supply reservoir.

U.S. Pat. No. 5,447,374 to Douglas S. Fraser et al. describes a method and device for positioning a probe, such as a temperature sensor, in a flask. A stopper adapted to be secured to an open end of the flask is provided having an opening through which a tube extends. A clamping mechanism is connected to the tube to secure the probe to the stopper. The clamping mechanism comprises a first flange, and a second opposing flange spaced slightly apart from the first flange. An O-ring positioned around the flanges causes them to flex inward to engage and secure the probe between them.

U.S. Pat. No. 5,489,532 to Stanley E. Charm describes an automatic test apparatus for use in a test method to determine antimicrobial drugs. The test apparatus comprises a frist aluminum, electrically heatable block with holes for the insertion of test containers and a separate, second cooling aluminum block adapted to be placed periodically in contact with the heated aluminum block to cool rapidly the heated block. The test apparatus includes timed signals existing therein to alert the test user. The test apparatus is adapted to provide for the timed sequential solid heating and cooling of one or more test containers containing a test sample.

U.S. Pat. No. 5,689,895 to David T. Sutherland et al. describes a device for positioning a probe, such as a temperature sensor, in a flask for freeze drying. The device includes a stopper adapted to be secured to an open end of the flask. The stopper has a center opening and at least one radial opening spaced from the center opening. The radial opening allows for fluid communication between inside and outside of the flask when the stopper is secured to the open end of the flask. The center opening receives a guide tube which extends into the flask and is sized to receive the probe such that substantially no fluid communication between the inside of the flask and the outside of the flask occurs through the guide tube or center opening. A channel formed in an upper surface of the stopper and the O-ring positioned about an outer diameter of a neck of the flask secure the probe in position relative to the guide tube. The multiple radial openings define an annular passageway which mimics fluid communication through a standard slit-type stopper employed in freeze drying.

U.S. Pat. No. 5,947,343 to Klaus Horstmann describes a flask for liquids, in particular an insulating flask, in which a pouring aperture can be closed by a lid which can be releasably attached to the flask. The lid is provided with a closure element which can be moved by a handle and is loaded by a spring element towards a closed position. The closure element is movable in a substantially vertical opening motion between an open position, in which the pouring aperture is released, and the closed position, in which the pouring aperture is closed. In order to ensure that the closure element is movable by an uncomplicated, durable mechanism, with the pouring aperture being easily openable and effectively closable during operation, the spring element is formed from a spring-elastic diaphragm connection the closure element to the lid.

U.S. Pat. No. 6,095,356 to Miriam Rits describes a vented flask cap having a body portion with proximal and distal ends with a generally cylindrical sidewall extending from the proximal end to the distal end of first and second support plates are formed at the proximal ed of the body portion and having a plurality of apertures extending there-through; a filter assembly is also provided which includes a first, lower membrane having a first porosity, a second, upper membrane having a second porosity and a radiation absorbing material disposed between the first and second membranes.

U.S. Pat. No. 6,502,456 B1 to Yaosheng Chen describes a method and an apparatus that are disclosed for the measurement of the aridity, temperature, flow rate, total pressure, still pressure, and kinetic pressure of steam at a downhole location within a well through which wet steam is flowing. The apparatus comprises a series of fiber optic sensors that are mounted on sections of a shell assembly. The apparatus is lowered into a well to different downhole locations, and measures the multiple parameters of steam at different locations and heights. The data can be stored on board for subsequent analysis at the surface when the apparatus is retrieved from the well. The apparatus is very reliable, accurate, and of long-life in harsh environments.

U.S. Pat. No. 6,615,914 to Li Young describes a reaction vessel system that includes a reaction vessel, a cooling unit functionally connected to the vessel to impart controlled cooling thereto; a heating unit functionally connected to the vessel to impart controlled heating thereto; and control means connected to the cooling unit and the heating unit for programmable automatic control of the cooling unit to control at least one of the on/off flow and rate of flow, and to control at least one of on/off heating and rate of heating, including a programmable device. The cooling unit includes a cooling element in proximity to the vessel with at least one inlet port for injection of a phase change coolant, a heat absorbent area and at least one outlet port for removal of the phase change coolant. This is an injector for injecting the coolant in liquid form via the inlet port to the cooling element. In preferred embodiments, the control means includes software, and the system includes an injection physical control device, for cyclical on/off control thereof to establish a predetermined temperature sequence involving a plurality of diverse, programmable temperature levels. The phase change coolant used in the present invention is an environmentally inert material which absorbs heat upon vaporization and has a boiling point below room temperature at atmospheric pressure, and may be selected from the group consisting of inert gases, carbon dioxide, and nitrogen.

European Patent No. EP 0 400 965 A2 to Kondo Akihiro describes a reagent reactor comprising a vial having an opening at one end thereof; a supporting block, having a first heater element, for surrounding and supporting said vial in a substantially erected position so that said opening of the vial is adjacent to the upper surface thereof and exposed to the outside thereabove; a cover block pressing against said supporting block under pressure and capable of sealing said opening of said vial including a fluid introducing tube projecting from said operating into said vial when the cover block is in the sealing position to the vial, a fluid discharging opening opposed to said opening when the cover block is in the sealing position to the vial, and a second heater element; and a temperature control circuit for controlling said first and second hater elements so as to maintain the temperature of the upper portion of aid vial and the lower end surface of said cover block which contacts said opening of said vial more than the temperature of the main body of said vial when a reagent is added to a sample contained in said vial so as to allow reaction of the reagent with said sample and when the evaporation or the azeotropy of a reagent or a solvent is performed.

Notwithstanding the prior art, the present invention is neither taught nor rendered obvious thereby.

### SUMMARY OF THE INVENTION

The present invention is directed to stand alone instruments for enhancing chemical and physical reactions on the “bench” level by providing a single instrument capability of performing a variety of functions on a plurality of reaction vessels at the same time (in parallel), that includes heating, cooling and five other functional capabilities, and more particularly to such instruments that provide the matrix of plural functions and plural reaction vessels, with the further ability of providing real time energy balance data on each reactor. Thus, the present invention instruments provide for any or all of heating, cooling, reflux, inert gas blanketing, vacuuming, stirring and evaporation at each reactor. (The words “reactor”, “microreactor”, “reaction vessel” and “vessel” are used interchangeably herein, and generally refer to bench scale flasks, beakers and other reactors used by bench chemists, biochemists, physicists, biologists, research doctors, and the like.) In some embodiments, the present invention instruments include cooling units which uniquely rely upon phase change coolant injections. In other embodiments, the present invention instruments include cofmger stoppers, described below. In yet other embodiments, the present invention instruments include both the phase change coolant systems and the cofinger stopper arrangements.

In the present invention instruments having the phase change coolant capabilities, one or more reaction vessel area, herein “work stations” includes a cooling unit functionally connected to the work station, and hence to the vessel to impart controlled cooling thereto; a heating unit functionally connected to the vessel to impart controlled heating thereto; and, control means connected to the cooling unit and the heating unit for programmable automatic control of the cooling unit to control at least one of on/off flow and rate of flow, and to control at least one of on/off heating and rate of heating, including a programmable device. While single cooling units, heating units, control means, etc., are described above and below in the singular, it should be understood that plural components, such as two or more cooling and/or heating units may be included at an individual work station, without exceeding the scope of the present invention.

The cooling unit includes a cooling element in proximity to the vessel with at least one inlet port for injection of a phase change coolant, a heat absorbent area and at least one outlet port for removal of the phase change coolant; and injection means for injecting the phase change coolant in liquid form via the inlet port to the cooling element. In preferred embodiments, the control means includes software, and the system includes an injection means physical control device, for cyclical on/off control thereof to establish a predetermined temperature sequence involving a plurality of diverse, programmable temperature levels. The phase change coolant used in the present invention is an environmentally inert material which absorbs heat upon vaporization and has a boiling point below room temperature (e.g., below 24° C.) at atmospheric pressure, and may be selected from the group consisting of inert gases, carbon dioxide and nitrogen. Preferably, there is a remote reservoir which contains a phase change coolant in a liquid state under pressure. The system also includes at least one and preferably two temperature sensors connected to the vessel with feedback to the microprocessor for automatic temperature control adjustments.

In those embodiments wherein the present invention includes a multiport cofinger stopper and a microreactor, as well as the cofinger stopper itself By “stopper” is meant an internal stopper (one that fits inside an opening of a microreactor) or an external stopper (one that fits over an opening of a microreactor). The microreactor has an opening and a hollow containment area of predetermined volume for conducting a chemical process, wherein the opening is generally cylindrical. The multiport cofinger stopper includes: a) a main housing having a top, a bottom, and a generally cylindrical sidewall, and b) sealing means on the sidewall of the main housing for sealably connecting the stopper to an opening of a microreactor (or to an open neck of an optional extension member connected to an open neck of a microreactor). The main housing has:
(i) a central orifice passing from said top to said bottom, said central orifice being located toward a center of said top, said central orifice including a cofmger; and,
(ii) a plurality of at least four outer orifices located about said central orifice, each passing from said top to said bottom. At least four outer orifices are preferred.

The device cofinger is a concentric set of at least two tubes, each of the tubes having an upper end and a lower end. By “concentric” is simply meant one inside the other. This could be symmetric or asymmetric. The cofinger may have one or more than one inner tube and has an outer tube. If there is more than one inner tube, these inner tubes may be concentric with respect to one another or may be next to one another, or even a combination thereof if three inner tubes or more are included. In some embodiments, each of the tubes is open-ended at its lower end. In other embodiments, the cofinger is a concentric set of two tubes, each of the tubes having an upper end and a lower end, wherein there is an inside tube having an open lower end and an outside tube surrounding the inside tube, with the outside tube having a closed lower end. This allows for flow of external materials through the tubes without contact with the contents of the microreactor, e. g. flask, such as cooling or heating liquid or gas.

In some embodiments, the sealing means is a tapering of the sidewall of the main housing to permit force fitting thereof into an open neck of a microreactor. In other embodiments, the sealing means is at least one O-ring located about the sidewall of the main housing. In yet other embodiments, the sealing means may be a clip that connects to both the reactor (or an extension thereof) and the stopper. Combinations of the foregoing and/or other known stopper attachments may be utilized without exceeding the scope of the present invention.

In some embodiments, the present invention device stopper main housing sidewall may be of a single diameter, or, with tapered sidewall, a decreasing sidewall diameter. Alternatively, the stopper may have an upper section and a lower section, wherein the upper section is of greater diameter than said lower section. In fact, in some of these embodiments, the upper section does not even have to be cylindrical, as it is not inserted into the neck of the microreactor. Thus, the upper section could have any footprint or shape, without exceeding the scope of the present invention. In other words, the main housing generally cylindrical shape should be construed to be in reference, minimally, to that portion of the stopper that is inserted into the neck of a microreactor.

In other embodiments, the present invention device stopper main housing may have a different shape to conform either to the shape of an opening into which it may be inserted, e.g. oval, square, etc., or to the shape of attachment capabilities of a microreactor wherein the stopper is an external stopper. For example, a rectangular reactor, with any shape opening, could best be connected to a rectangular external stopper.

In some embodiments, the device cofinger is a concentric set of two tubes, including one outside tube and at least one inside tube, and wherein at least one of said inside tubes includes an elbow section extending through and outward from said outside tube. This elbow section may be located above the top of the main housing, and extend through the outside tube into an open area. Alternatively, the elbow section may be located within the main housing and extend through and outwardly from the sidewall of the main housing. Thus, it would protrude through the side of the stopper at an area above where it would be inserted into a microreactor, or fit over a microreactor opening.

The stopper main housing may be made of material that is selected from the group consisting of metal, glass, rubber, plastic and combinations thereof. One choice material is aluminum, and another is stainless steel. The tubing may be of the same or different material from the stopper, and is usually made of rigid glass, metal polymer or plastic, and may typically be connected to a fixed or flexible conduit, such as flexible plastic tubing, rigid PVC piping, copper piping or tubing or the like.

The present invention stopper central orifice and the outer orifices may be used for many different functions. In some instances, the microreactor needs to be airtight and pressure tight. In some instances, injection input may be needed. In others, tracking of physical characteristics is essential. Others require combinations of the foregoing. Thus, in some embodiments, at least one of the outer orifices includes a closed injection port. In some, at least one of the outer orifices and the cofinger includes gas blanket input means and another of the outer orifices and the cofinger includes gas blanket output means, wherein the gas blanket input means is connected to a gas blanket gas source with input control means. At least one of the outer orifices and the cofinger may include physical characteristic measuring means. The physical characteristic may be selected from the group consisting of temperature, pressure, viscosity, pH, and thermal conductivity.

In some embodiments, the present invention device may further include an attachment clamp connected to both the stopper and the microreactor to hold the stopper to the microreactor under internal pressure. It could also or separately include an extension member located between said microreactor and said stopper.

The present invention instruments include control means for controlling all of the functions for each of the work stations. In other words, each work station may be controlled separately from all of the others. Further, in preferred embodiments, the controls are sate of the controls that rely upon one or more internal microprocessors and/or CPUs to permit a user to monitor, to preprogram and to adjust any and all work stations. Thus, a keypad, touchpad, voice responsive voice controlled or other input means is provided, and this may be integrally established (built into) the instrument housing, or remotely located (by inches or miles) and connected by wire or wirelessly. In one preferred embodiment, the present invention instrument has a built-in touch pad, signal displays, a CPU, microchips and energy balance readouts, storage and report printouts for each work station. One such present invention instrument has seven work stations and provides the aforesaid seven functions. Hence, this particular unit, a professional seven function, seven work station instrument, is a multifunctional, multireactor instrument referred to as the PRO 77.

### BRIEF DESCRIPTION OF THE DRAWINGS

The present invention should be more fully understood when the specification herein is taken in conjunction with the drawings appended hereto wherein:

FIG. 1 is a graphical representation of the time sequence of cooling injector on-off cycling to accomplish the cooling temperature-time sequence shown in FIG. 2. FIG. 3 shows the variation in percent injection cooling time sequence of the cooling injector used in conjunction with the cooling injector on-off sequence shown in FIG. 1 to accomplish the cooling temperature-time sequence of FIG. 2.

FIG. 4 is a schematic diagram of the present invention reaction vessel system, and two representative embodiments of the reaction vessel system are shown in FIGS. 5 and 6.

FIG. 7 shows a top view of present invention multiport cofinger stopper;

FIG. 8 shows a side cut view of the present invention stopper shown in FIG. 7, with identical parts identically numbered;

FIG. 9 shows an alternative embodiment present invention stopper with different features from the stopper described above;

FIG. 10 shows a present invention stopper that has two different diameter sections;

FIGS. 11 and 12 show oblique views of present invention stoppers with differing cofinger arrangements;

FIG. 13 shows a microreactor extension member, and FIG. 14 shows a clamp, each of which may be utilized with a present invention device;

FIG. 15 illustrates a present invention device with three separate connective functions;

FIG. 16 shows a present invention device with an extension member and five orifices being used for different functions;

FIG. 17 shows the same present invention device as shown in FIG. 16, but with additional features now included.

FIG. 18 shows a present invention multifunctional, multireactor instrument from a perspective view with no reactor vessels therein, and FIG. 19 shows the same instruments, but with reactor covers in place;

FIG. 20 shows a partial view of the same present invention instrument as shown in FIG. 18, but with additional features now included;

FIG. 21 illustrates a reaction vessel for a reflux type reaction with various functional connections and a cofinger stopper as may be used as a component of a present invention instrument;

FIG. 22 shows a partial view of the same present invention instrument as shown in FIG. 18, but with additional features now included. Combined with FIG. 20, it is shown also in FIG. 23, with the vessel and components of FIG. 21 also included, in an exploded view;

FIG. 24 shows an oblique view of the same present invention instrument as shown in FIG. 18, but with three reactor subsystems in place, one for a room temperature reaction under inert gas blanket, one for a room temperature reaction without a gas blanket, and one for a high temperature reaction;

FIG. 25 is the same as FIG. 24, except that it now includes another reactor, this being for a solvent evaporation process;

FIG. 26 is the same as FIG. 25, except that it now includes additional reactors, these being for a reflux reaction shown above, a below room temperature reaction under inert conditions, and a high temperature air sensitive reaction;

FIGS. 27, 28, 29, 30, 31, 32, and 33 illustrate various details of the different reactor arrangements in the previous Figures in partial, cut, enlarged views;

FIG. 34 shows a present invention instruments with two reaction vessels that are interconnected for a single process with plural steps, occurring in the different reactors sequentially; and,

FIGS. 35 through 41 show chemical and physical processes that are examples for uses of present invention instrument vessel arrangements.

### DETAILED DESCRIPTION OF THE PRESENT INVENTION

The present invention is directed to single (stand alone) instruments for performing a variety of functions on a plurality of reaction vessels at the same time (in parallel), that includes heating, cooling, stirring, evaporation, refluxing, gas blanketing and vacuuming, and more particularly to such instruments with cooling units that may uniquely rely upon phase change coolant injection. Further, the instruments may include unique cofinger microreactor stoppers for the vessels to enhance efficiencies and to provide many different input and output ports without interference with one another. The instruments also include preprogrammable features for controlling the functions of each work station independently of one another.

The present invention instruments include work stations with reaction vessel systems that include programmable temperature /time sequences utilizing a microprocessor, a heating unit and a cooling unit. With this system various reaction requirements are automatically achieved, such as heating/cooling, cooling/heating sequences, refluxing, evaporating, condensing, distilling and other steps necessary to achieve desired reaction conditions. The present invention preferred cooling unit uniquely relies upon phase change coolants where the endothermal heat of evaporation is absorbed from the reaction vessel when the phase change coolant is injected into the heat absorbing area with a programmable device, e.g. a computer, controlled injector. Environmentally inert phase change coolants are utilized and evaporated and dissipated to the atmosphere in gaseous form.

The reaction vessel utilized in the present invention may be any form of reaction vessel capable of transmitting heat therethrough to add or remove heat during a reaction process. Thus, the vessel may be glass, ceramic, cement, metal or other material, and may be opened or closed and at atmospheric pressure, fixed pressurized or variably pressured. It will have connected thereto (inside, outside, both or embedded) at least one temperature sensor, e.g. a thermocouple, to sense temperature. It preferably has at least two temperature sensors, for example, one at an upper portion of said vessel and one at a lower portion thereof. The temperature sensors are connected to the control means, which has a programmable device, e.g., a computer, a microprocessor or other known devices as its central component.

The heating unit is one which may be automatically controlled, either by off/on sequencing or amount of heating (rate) or both. The heating unit may be conductive, convective, radiant, directly or indirectly, e.g. by heat exchanger or combination of heating mechanisms but is typically a steam heating element or an electric heating element type unit, with electrical convection to the microprocessor.

The heating unit may be a flat plate, a nest for the reaction vessel, an annular unit to encompass the reaction vessel, a wrap, a coil or any shape otherwise functionally connected to the vessel, i.e. connected directly or indirectly, permanently or temporarily thereto, to impart heat to at least a portion of the vessel, e.g., at its lower portion.

The heating unit and cooling unit may be in close proximity to one another or spaced apart substantially depending upon the actual needs for the reactions of the reaction vessel.

The cooling unit of the present invention, like its heating unit counterpart, may take on any physical shape to accommodate the heat transfer (removal for cooling) relative to the reaction vessel. Critically, the cooling unit of the present invention includes a cooling element with an inlet port, a heat absorbing area and an outlet port or a plurality of one or more of these components. It also includes injection means at the inlet port for controlled injection of phase change coolant. While the present invention system may be manufactured and sold in various configurations without a phase change coolant supply, in actual use a phase change coolant supply is essential, e.g. by attachment of one or more pressurized inert liquid tanks or with a generator, or a compressor or other coolant creating, compressing or storing means.

The cooling element may be a coiled tubing or a molded, machined or an otherwise-formed open area within the cooling unit to permit injection of phase change coolant and is preferably adjacent to the reaction vessel itself. In other words, the open area of the cooling element is enclosed, e.g. with materials of construction which preferably include insulative characteristics. The phase change coolant is injected into the heat absorbing area at the inlet port and evaporates under normal pressure to its gaseous state and exhausts as gases through the outlet port. It is the endothermic heat of evaporation to the phase change coolant that absorbs heat from the vessel to effect cooling.

The phase change coolant may be any material which evaporates below room temperature, e.g. preferably below 24° C., and most preferably, below 0° C. Such materials are liquid under pressure and may be stored as such in storage reservoirs, e.g. tanks, for subsequent use or otherwise provided as described above. These coolants go through at least one phase change to effect a net heat absorbing transition, are environmentally inert, i.e. harmless to the environment when dissipated, and include such phase change coolants as are presently and/or will become commercially available. They include, but are not limited to, the elements known as inert gases, carbon dioxide, nitrogen, etc. The cooling mechanism of the current invention is based on the heat exchange during the phase change of coolant material and physical condition of the nozzle. A precise heat exchange control can be readily achieved by an appropriate selection and adjustment between either liquid to gas or a sequential phase change of liquid to solid then solid to gas. Commonly used coolants are pressurized liquid carbon dioxide, or pressurized liquid argon, or pressurized liquid nitrogen. Pressurized liquid carbon dioxide is preferred because it can be easily used to accommodate the critical point, which is very close to the room temperature at atmospheric pressure.

The injection means will typically include an injection nozzle, such as a stainless steel nozzle, a valving mechanism and a supply line, with the valving mechanism directly upstream from the injection nozzle. (In cases where small diameter tubing or inlet means is used, then such tubing or inlet means may also act as the nozzle itself, without added hardware.) The valving mechanism may be a flap or shutter valve or other on/off valve, or it may be a controlled opening (flow rate controlling valve) such as a stem valve or gate valve. The on/off valve mechanisms may be opened and closed by solenoids or switches or other known devices, and the flow controlling valves may be opened and closed by servo-drivers or other rotating or lifting devices. In a more complicated system, both types of valves, i.e. on/off and flow rate controlling valves may be used to offer both types of controls in the system.

The control means is any programmable device, such as manual switches, dials, buttons, levers, etc., with sensors for feedback, a computer or microprocessor with appropriate software or sequence input, external inputs and wiring to the cooling unit, to the heating unit and preferably, to the reaction vessel. More specifically, the programmable device may have output information available to a user, e.g. a microprocessor may have a display which includes a readout and programming inputs. For example, it could have a plurality of buttons, input means, selection means, switches, keypads, etc., with choices including “SEQUENCE NUMBER”, “TEMPERATURE” and “TIME” with a numerical keyboard, and the microprocessor itself will divide when to use the heating unit and when to use the cooling unit to achieve the programmed temperatures for the specified times. The “TIME” inputs could be elapsed time needs or actual clock start and end times. In a more preferred embodiment, additional buttons, controls, inputs, icons, selections, etc. could include “HEATING UNIT” and “COOLING UNIT” selections so that both units could operate simultaneously or separately or both, as the user may desire other control inputs/outputs should now be evident to the artisan. In yet another embodiment, a user may be offered the opportunity to select proportional controls for flow, tolerances from a predetermined set of choices and other parameters, as a designer may offer to end users. Also, the programmable device may have time delay input capabilities before start-up is initiated or even offer unlimited off sequences between heating and/or cooling sequences for inputted periods of time. Other programming possibilities should now be apparent to the artisan without exceeding the scope of the present invention.

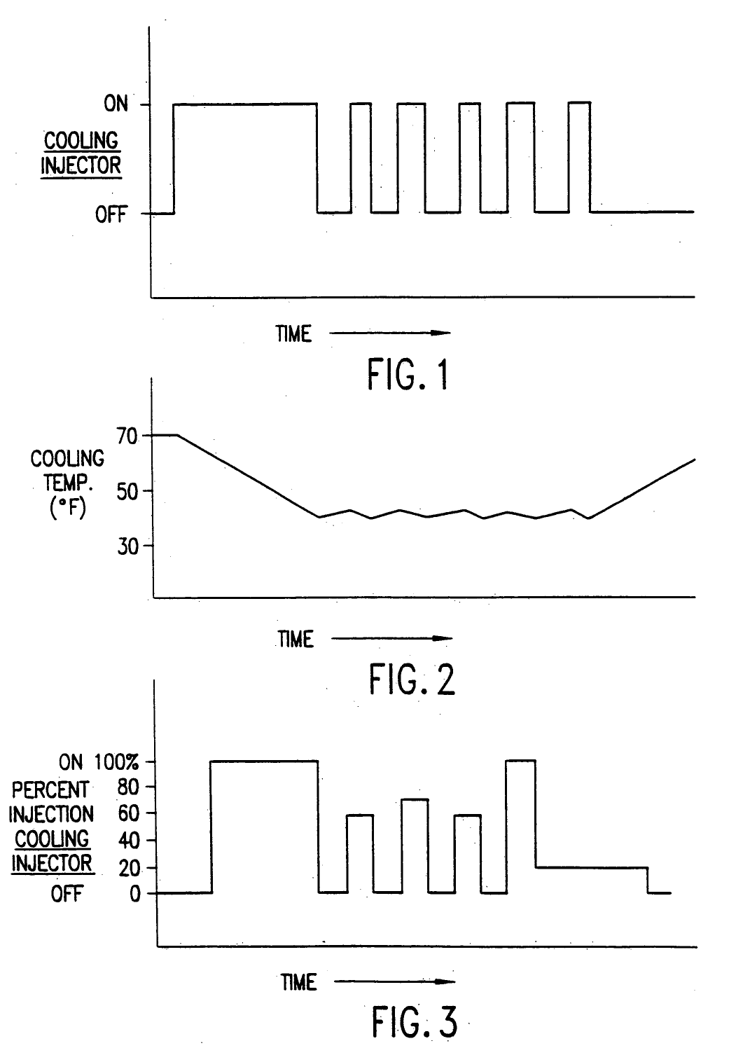

The total configuration of the system may be portable or somewhat permanent depending upon the size of the reaction vessel and the particular needs, and would be enclosed by the instrument main housing. Further, while the drawings described below are merely diagrammatic, actual embodiments would have appropriate support structures and in preferred embodiments, the reaction vessel itself may be movable from the remainder of the system, for reaction product removal, cleaning, etc. Additionally, while the drawings illustrate the system simplistically, it should be understood that spatial relationships are not limited to those shown. For example, in distillations and condensing, a reaction vessel may have a side arm or condensing tube and the cooling unit may be connected thereto rather than directly above the heating unit, without exceeding the scope of the present invention. The following FIGS. 1 through 6 below describe the details of those present invention embodiments that include phase change cooling systems:

Referring now to FIGS. 1 and 2, there is shown a typical cooling temperature versus time sequence to be controlled within the reaction vessel by the system which is shown in FIG. 2. The cooling injector on-off time cycling, controlling injection of coolant into the system cooling unit, implemented by the system controller to accomplish this temperature-time cycle is shown in FIG. 1. In addition, FIG. 3 shows the time cycling of the percent injection cooling controlled by the injector, which is the modulation of the rate of injection of coolant into the reaction vessel cooling unit, implemented by the controller in combination with the cooling injector on-off cycling of FIG. 1, to accomplish the temperature-time sequence in the reaction vessel of FIG. 2.

While the foregoing discussion pertaining to FIGS. 1, 2 and 3 above are specifically directed to cooling units, similar illustrations, discussions and control techniques could also be applied to heating units of the present invention.

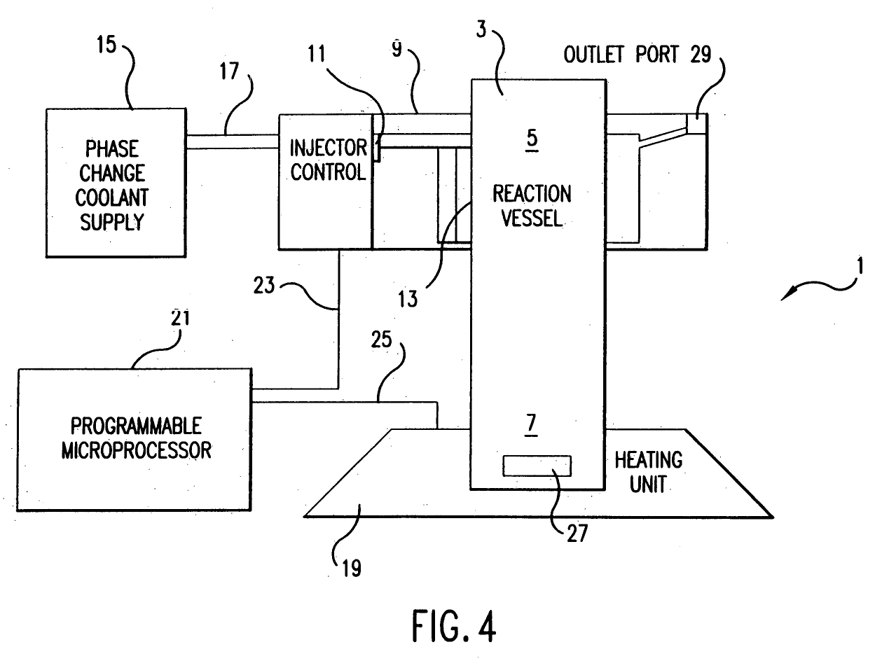

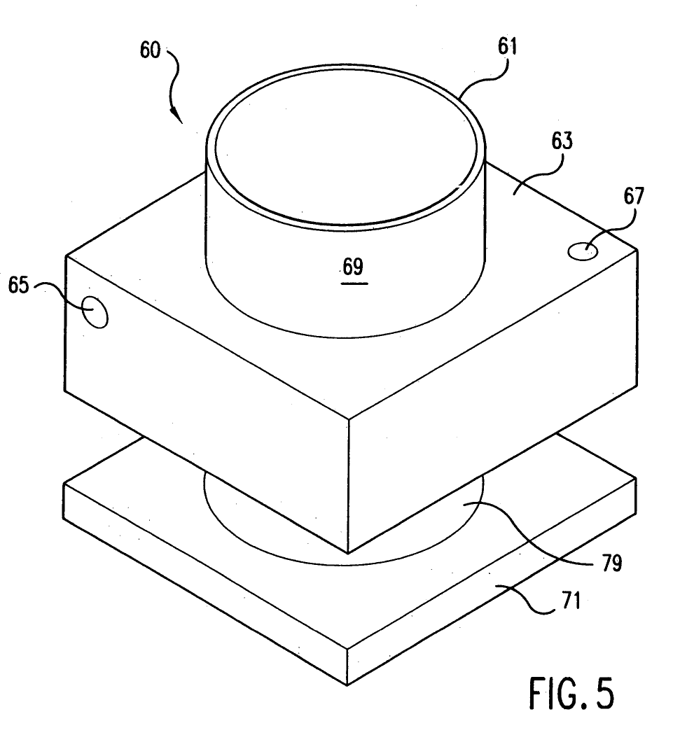

A schematic diagram of the heatable, coolable reaction vessel system 1 is shown in FIG. 4. The reaction vessel 3 has a cooling section 5 and a heating section 7. Inlet port 9 provides coolant from injector control 11 to cooling unit 13. Cooling unit 13 physically surrounds and connects to cooling section 5 of the reaction vessel 3 to transfer heat from section 5 to the coolant in the cooling unit 13. Outlet port 29 ejects spent coolant from cooling unit 13 to the atmosphere. A supply of phase change coolant 15 is connected to coolant injector 11 via conduit 17, and thereby into coolant unit 13.

Heating unit 19 is shown at the heating area 7 of reaction vessel 3. The heating unit physically surrounds and connects to heating area 7 of reaction vessel 3 to transfer heat into the vessel as needed to control the chemical reactions occurring in reaction vessel 3.

Programmable microprocessor 21 is the control means for the reaction vessel system, and is connected to the coolant injector control 11 via cable 23 and to heating unit 19 via cable 25 to implement the required temperature-time cycling desired within the reaction vessel, and programmed into the microprocessor 21 for execution.

A magnetically operated stirring device 27 is shown within the reaction vessel in heating area 7.

FIG. 5 is a perspective view of one embodiment of the reaction vessel system 60. Reaction vessel 61 has cooling section 69 and heating section 79. Surrounding cooling section 69 of the reaction vessel 61 is cooling unit 63 with phase change coolant inlet port 65 and phase change coolant outlet port 67. Heating unit 71 is shown surrounding heating section 79 of reaction vessel 61.

FIG. 6 shows a perspective view of a second embodiment of the reaction vessel system 101. Reaction vessel 103 has an upper section 111 with a cooling unit 105 having phase change coolant inlet port 107 and phase change coolant outlet port 109. Also shown is heating section 113 of reaction vessel 101 surrounded by heating unit 115. Magnetically operated stirring device 117 is shown inside reaction vessel 103.

The magnetic stirring device 117 is provided in a preferred embodiment of the reaction vessel system to asset in promoting the chemical reactions occurring in the reaction vessel which are being controlled by the cooling and heating subsystems. The magnetic stirring device is actuated by a magnetic drive mechanism located within the heating unit 115 at the heating area 113 of reaction vessel 103. The required operating cycle of the stirring device during a particular reaction time sequence is controlled by the programmable controller 21 in FIG. 4.

The foregoing describes preferred embodiments of the present invention, and FIGS. 4, 5 and 6 illustrate upper reaction vessel cooling units and lower reaction vessel heating units. These may be reversed, or multiple heating and/or cooling units may be included in any useful arrangement without exceeding the scope of the present invention. Likewise, any sequence of heating/cooling or cooling/heating or repeats, reverses or even simultaneous heating and cooling may be effected by the present invention.

Also, as mentioned above, the heating and cooling units of the present invention instruments may be directly or indirectly connected thermally to the reaction vessel. Indirect connection may include, for example, baths, such as oil baths, water baths or gel baths; others may be other heat exchange media, such as flowing gases or solids or combinations. In those present invention embodiments that do not include phase change cooling, the cooling system may be any cooling system known, such as liquid cooling, and any known heating system, such as convection heating or resistance heating.

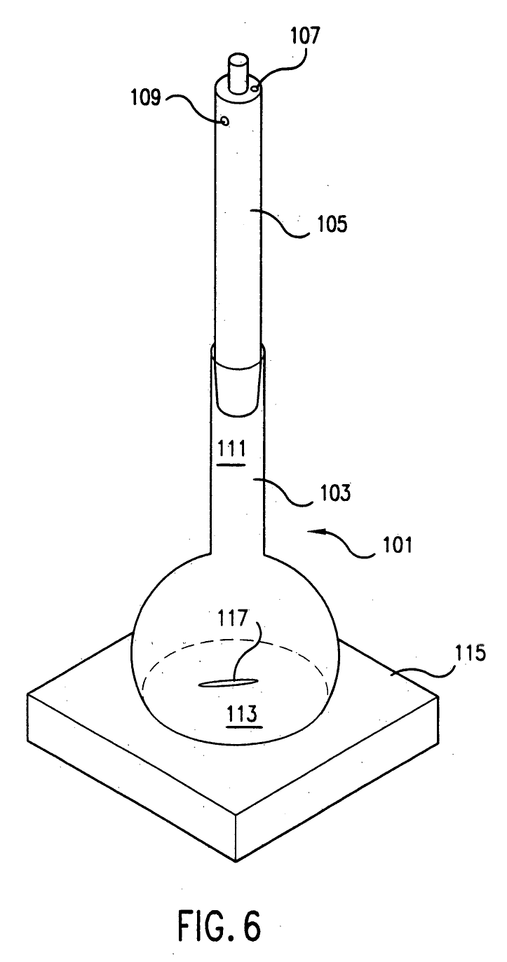

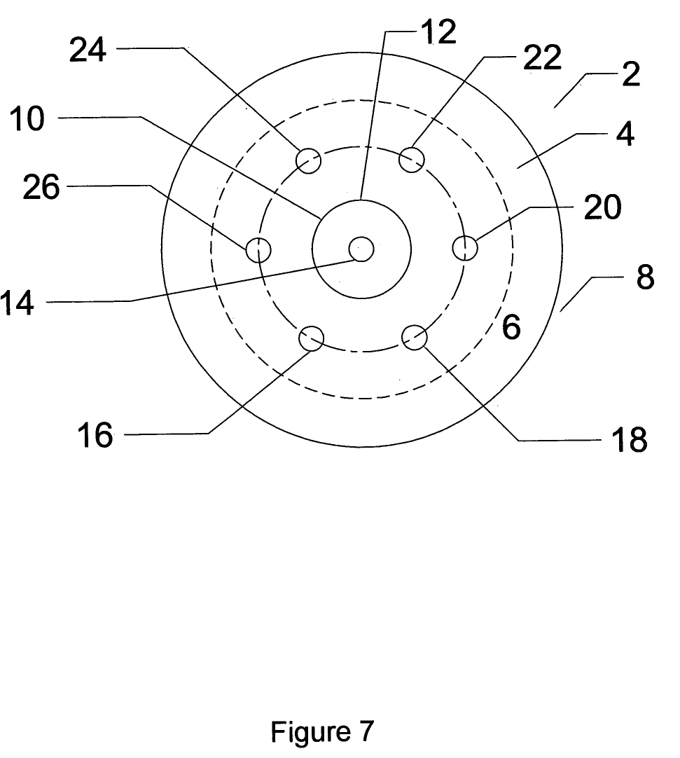

The following FIGS. 7 through 17 below describe the details of those present invention embodiments that include the use of cofinger stoppers with the reaction vessels (microreactors), and the discussion is focused on the cofinger technology. Subsequent Figures describe further details of the present invention instruments incorporating the phase change cooling and/or cofinger features:

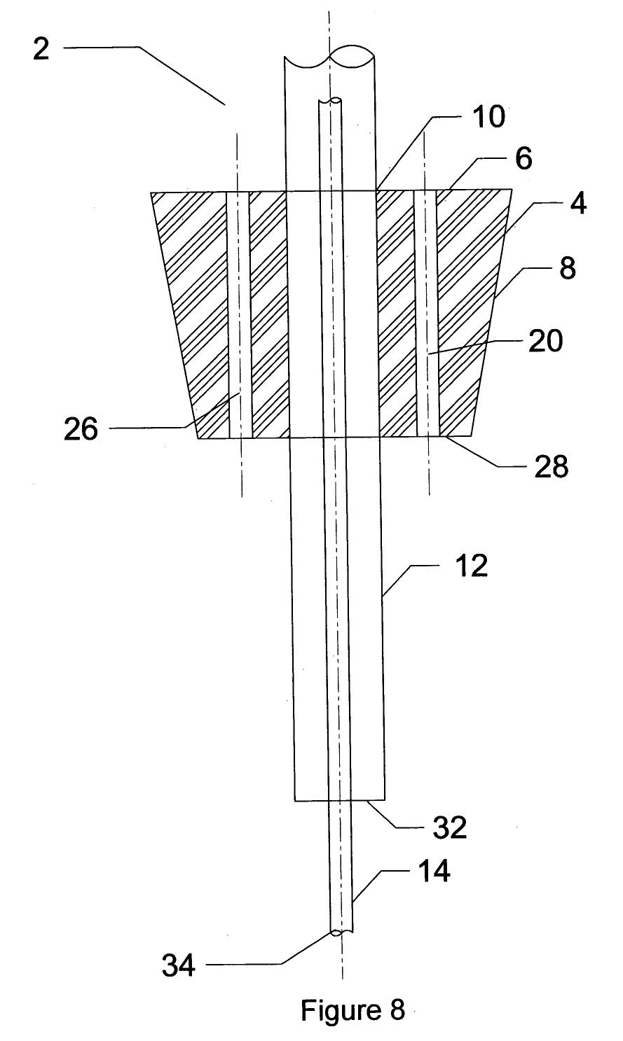

FIG. 7 shows a top view of present invention multiport cofinger stopper 2 and FIG. 8 shows a side cut view of present invention stopper 2 shown in FIG. 7, with identical parts identically numbered. Both Figures are now discussed together. Stopper 2 includes a main housing 4 with a top 6, a sidewall 8, and a bottom 28. There is a central orifice passing from top 6 to bottom 28 shown generally as orifice 10. There is a plurality of concentric outer orifices 14, 16, 18, 20, 22, 24, and 26 that also run from top 6 to bottom 28.

FIG. 8 shows a side cut view of present invention stopper 2 shown in FIG. 7. Central orifice 10 includes a cofinger established by outer tube 12 and inner tube 14. In this embodiment, both outer tube 12 and inner tube 14 have open ended lower ends 32 and 34, respectively. These could be used simultaneously to add two separate constituents to the center of a reaction solution. Alternatively, they could be used to maintain a fixed volume within a desired height range by adding or removing materials. Other uses would now be apparent to one skilled in the art.

Stopper 2 has a tapered side wall with slight resilience so that it may be pushed into an open neck of a microprocessor and force-fitted therein for use in combination with a microprocessor.

The central orifice is shown to be on center in FIGS. 7 and 8, but need not be in the center to be centrally located. Likewise, the outer orifices need not be of identical spacing or distance from center. Although symmetry is aesthetically appealing, it is not essential to the functionality of the present invention.

The outer orifices or the central orifice may be used for insertion of reactants, solvents, dilutents, or any other materials, solid, liquid or gaseous. Alternatively, any of the orifices may be used to remove material from the microreactor. The outer orifices may be used for sensing physical characteristics, such as temperature, thermal conductivity, pressure, viscosity, electrical resistance or any other characteristic by insertion of one or more probes. They may be used for inert or reactive gas blanketing or removal. They may be used for combinations of the foregoing simultaneously, sequentially, continually or continuously or as otherwise desired.

The central orifice includes a cofinger that may be used for any -one or more of the above-stated purposes and is ideal for cooling or heating when the outer tube is closed at its lower end so that hot or cool liquid or gas may flow in one tube and out the other so as to heat or cool the contents of the microreactor without physical contact therewith.

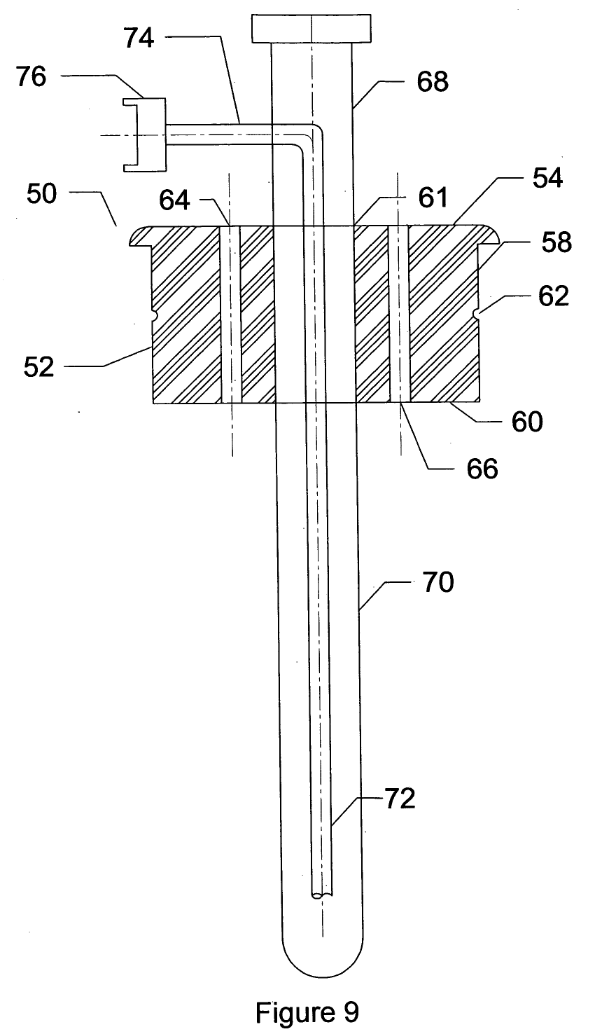

FIG. 9 shows an alternative embodiment present invention stopper 50 with different features from stopper 2 described above. Stopper 50 includes a mainhousing 52 with a top 54, a side wall 58, a bottom 60 and a central orifice 61. It also has a set of eight separate outer orifices that are shown in cut view FIG. 9 as represented by orifices 64 and 66.

Embedded in central orifice 61 is a cofinger 68 that included a closed outer tube 70 and an open inner tube 72. Inner tube 72 includes an elbow 74 with attachment means 76. Instead of a taper, stopper 50 has an O-ring 62 for sealing means.

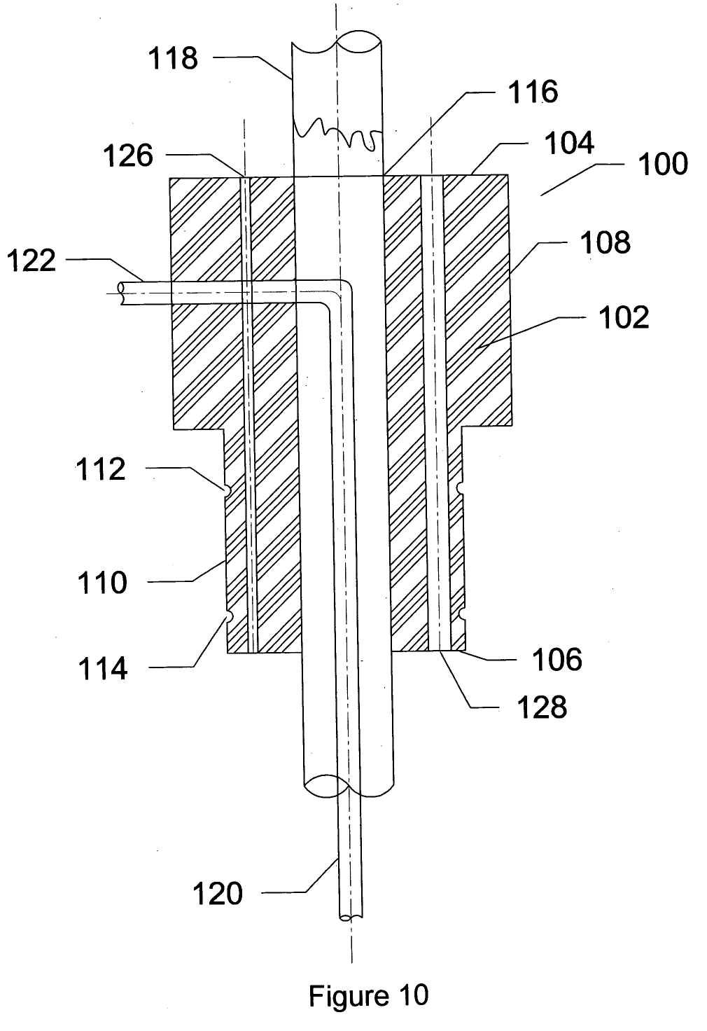

FIG. 10 shows a present invention stopper 100. Stopper 100 includes a mainhousing 102 with a top 104 and a bottom 106. There is a side wall having an upper section 108 and a lower section 110. The diameter of side wall upper section 108 is greater than the diameter of side wall lower section 110, as shown. Lower section 110 fits into an open neck of a microreactor such as a flask, beaker or other bench-scale reactor. It is held in place and sealed via dual O-rings 112 and 114. A central orifice 116 includes outer tubing 118 and inner tubing 120 to form a cofinger. Additionally, there are a plurality of different size outer orifices (at least four) as represented by outer orifices 126 and 128.

In this particular embodiment, inner tube 120 has an elbow 122 that exits outer tube 118 and exits through the side wall of main housing 102, as shown.

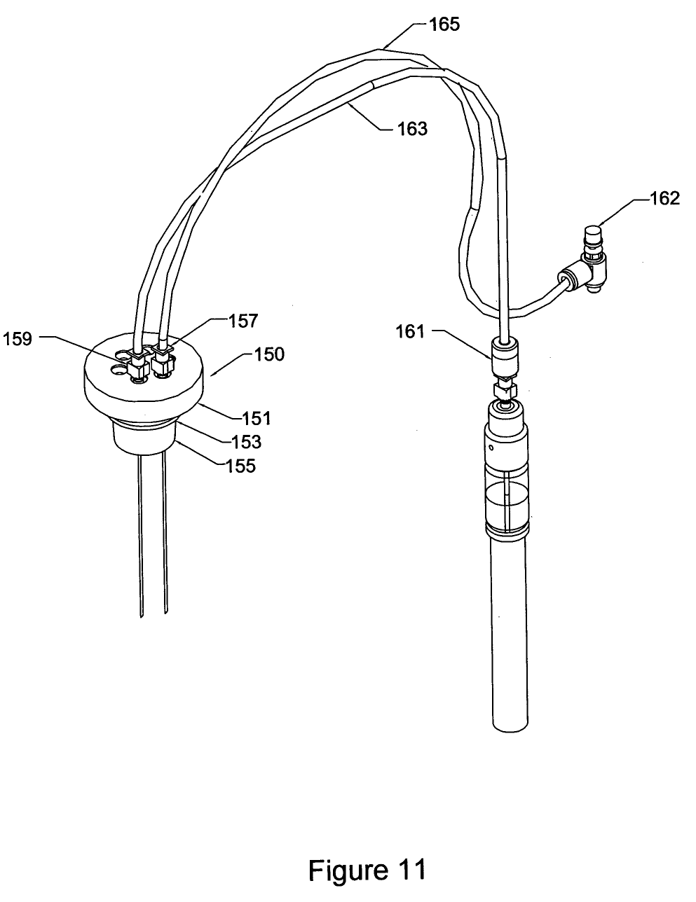

FIG. 11 shows a present invention device 150 with stopper 151 having an upper portion 153 and a lower portion 157. There is a central orifice 157 and five outer orifices such as outer orifice 159. There is a gas bubbler 161 connected to tubing 163 for gas input. There is a separate output line 165 with a controlling valve 167. This is used in environments wherein central orifice 157 may be used in closed, sometimes pressurized, environments. Central orifice 157 would include a cofinger with probes or other components connected thereto, as desired. Alternatively, the central orifice 157 could be connected to evacuation means for removing gas or liquid or both.

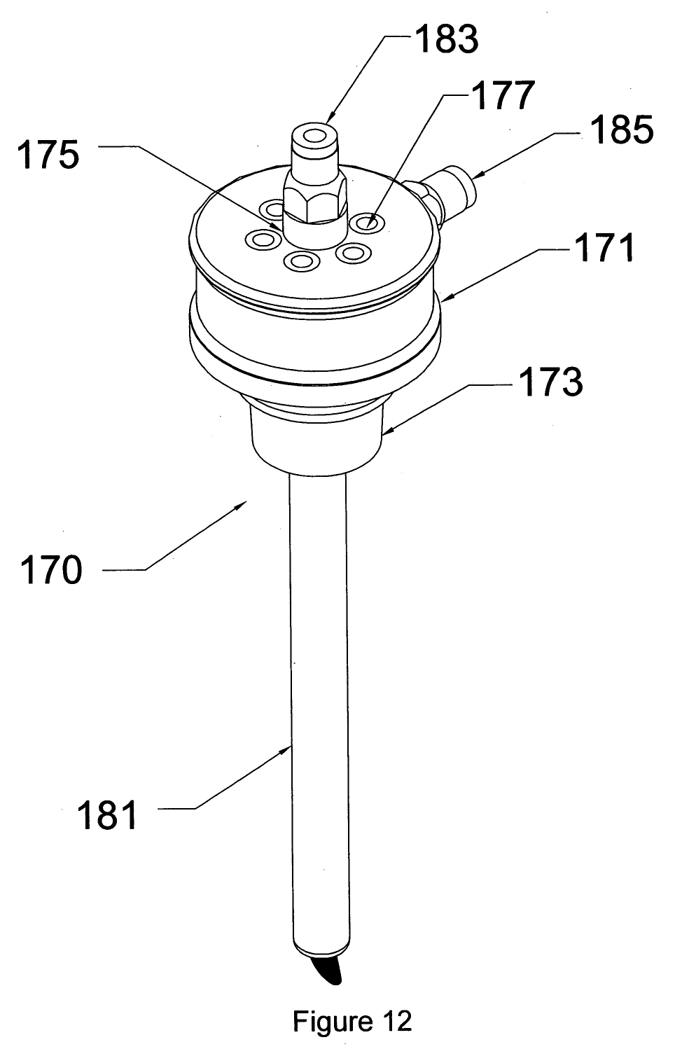

FIG. 12 shows another present invention stopper 170. It includes an upper section 171 and a lower section 173 with a central orifice 175 and six outer orifices such as outer orifice 177. Cool finger cofinger 181 has a top-exiting outer tube 183 and a side wall-exiting inner tube 185. Any of the outer orifices could be used to create pressure, or to evacuate, to measure physical parameters, to remove product, to add reactant or dilutent or some combination thereof.

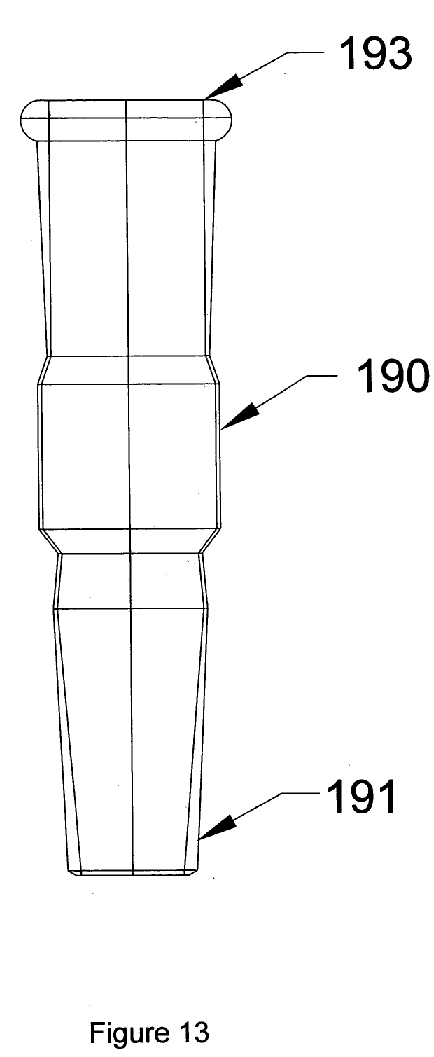

FIG. 13 shows a microreactor extension member 190. It has a narrow bottom neck 191 for insertion into an open neck of a microreactor. It has a wider open top neck 193 for receiving a present invention stopper.

FIG. 14 shows a top view of a stopper clamp 195 that may be connected to both a stopper and a microreactor for clamping the stopper to a microreactor under pressurized conditions.

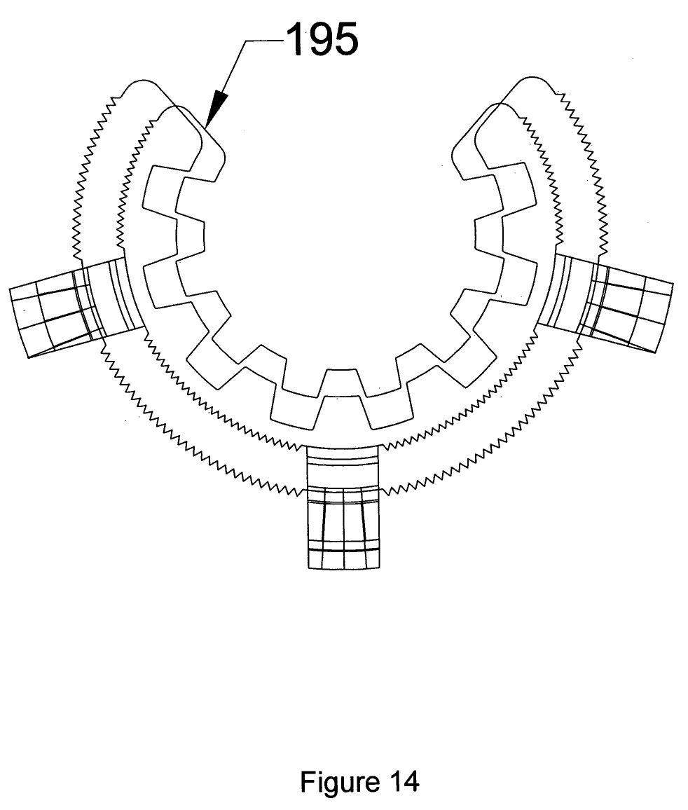

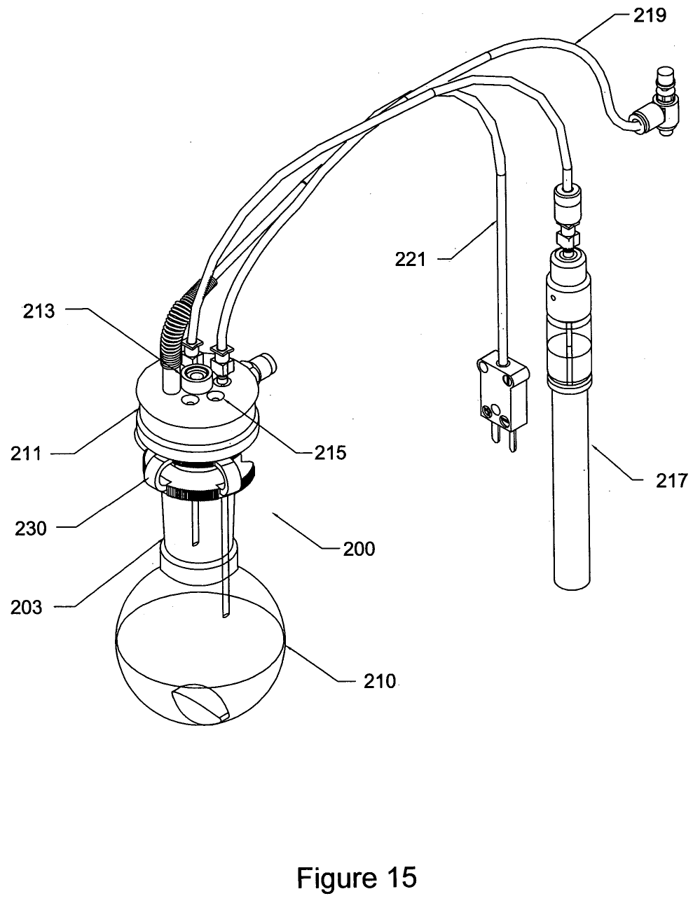

FIG. 15 shows an oblique view of a present invention device shown generally as device 200. It includes a microreactor 201 with an open neck 203. Stopper 211 has a central orifice 213 and a plurality of outer orifices such as outer orifice 215. Stopper 211 is similar to stopper 1 shown in FIG. 7. A gas bubbler 217 is connected to one outer orifice for blanket gas input and output to tube 219 is connected to another outer orifice for blanket gas output. Thermocouple sensor 221 is connected to the central orifice cofinger 213 to permit exhaust gas exiting and simultaneous temperature measuring. The remaining outer orifices may be open or closed and may or may not include injection ports. Clamp 230 may be used to maintain stopper 211 in sealed position on microreactor 201.

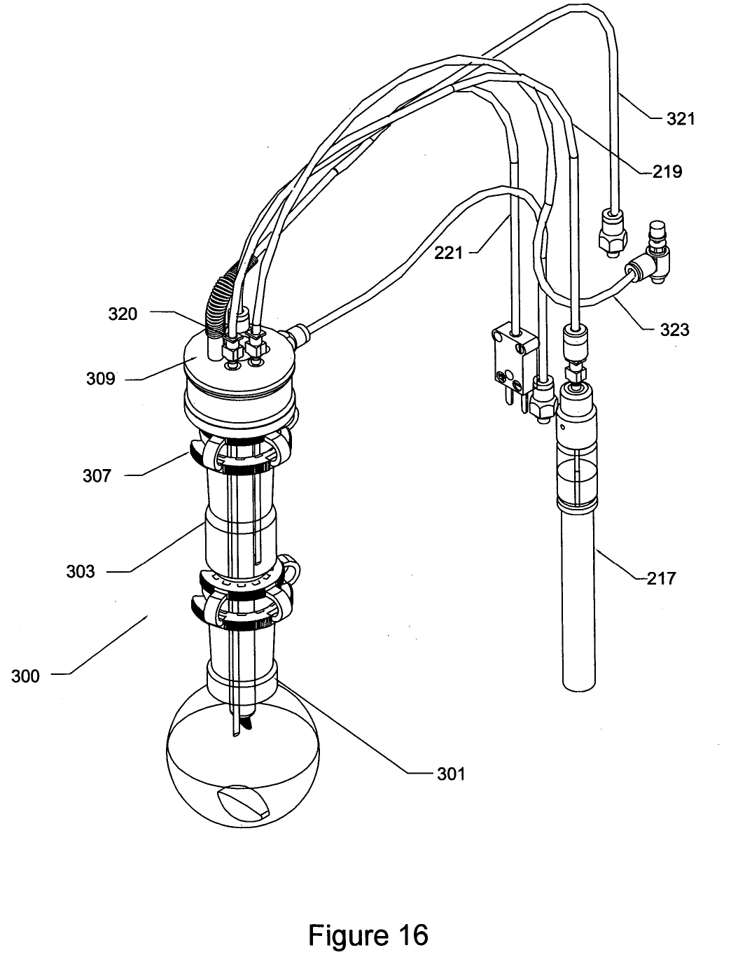

FIG. 16 shows an alternative embodiment present invention device 300. It includes microreactor 301 with open-mouthed neck 303, extension 305, clamp 307, and stopper 309. In this embodiment, some of the orifice connections shown in FIG. 11 are also shown here and are identically numbered. Additionally, the thermocouple 221 is located in an outer orifice, and a closed loop cool finger cofinger is contained within central orifice 320. This includes cooling water input 321 and cooling water output 323.

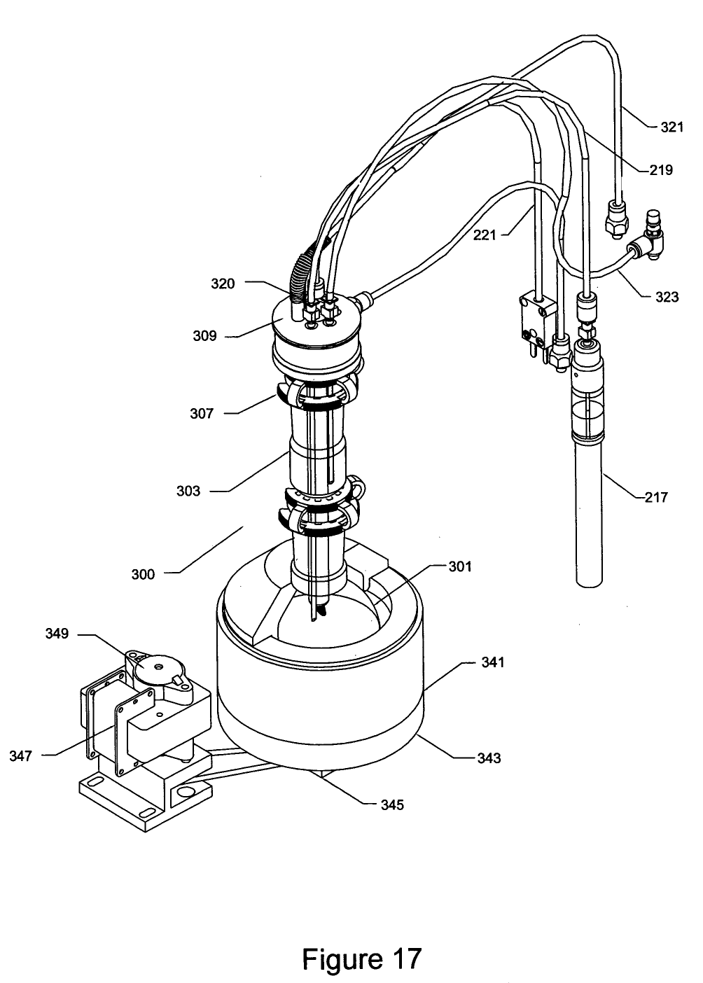

FIG. 17 shows the same present invention device 300 as shown in FIG. 16, but with additional features now included. Identical parts from these two figures are identically numbered. Here, microreactor, 301 is located in an insulation cylinder 341 with an insulated bottom 343 containing a bottom-based heating and cooling mechanism 345. Magnetic stirring device 347 and controls 349 are also included.

The following Figures describe the present invention instruments in their overview and functionality, as well as in details:

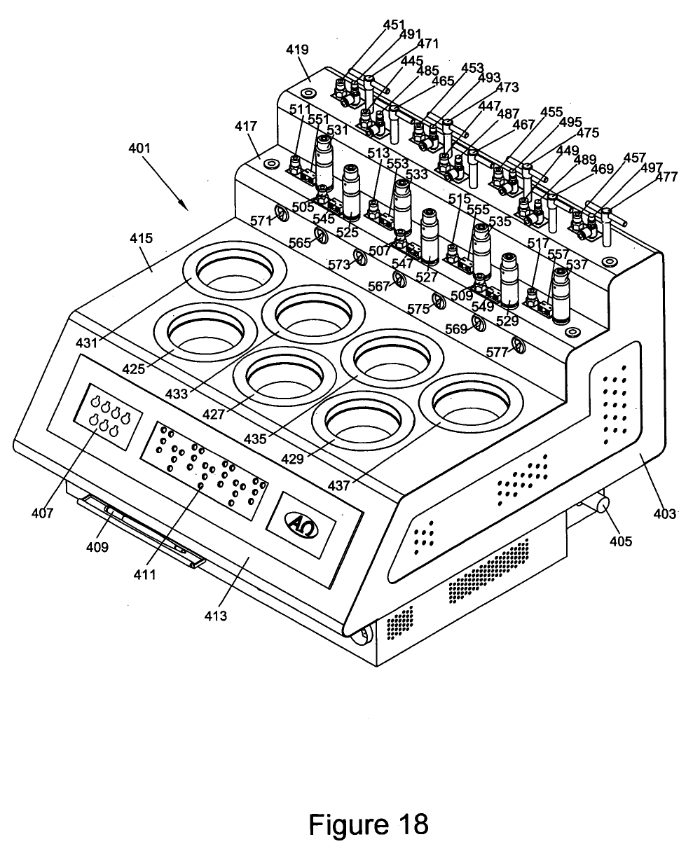

FIG. 18 shows a present invention multifunctional, multireactor instrument 401 from a perspective view with no reactor vessels therein, and FIG. 19 shows the same instrument 401, but with reactor covers in place. Common components to both Figures are identically numbered. Instrument 401 includes a Main Housing 403, a Pressure Controller 405, and a Microprocessor Programming Touchpad 407, with Stylus 409. A central processing unit is contained inside the Main Housing 403 to control the functions of each work station independently. The Touchpad 407 is used to set temperature, flow of gas, coolant flow etc. either through manual specific settings or through programming based on desired controlled parameters. Front Panel includes 413 Heating, Cooling, Refluxing and Stirring Indicators, such as 411, for each work station. Note that the Main housing 403 may be made of metal or plastic or combinations thereof, and metal such as aluminum is one material of choice.

The following is a parts list for the instrument 401, naming the remaining components shown in FIG. 18:

| | |
|---|---|
| Top Panel | 415 |
| Middle Tier Panel | 417 |
| Top Tier Panel | 419 |
| 1st Work Station | 425 |
| 2nd Work Station | 427 |
| 3rd Work Station | 429 |
| 4th Work Station | 431 |
| 5th Work Station | 433 |
| 6th Work Station | 435 |
| 7th Work Station | 437 |
| Water Feed for 1st Work Station | 445 |
| Water Feed for 2nd Work Station | 447 |
| Water Feed for 3rd Work Station | 449 |
| Water Feed for 4th Work Station | 451 |
| Water Feed for 5th Work Station | 453 |
| Water Feed for 6th Work Station | 455 |
| Water Feed for 7th Work Station | 457 |
| On/Off Valve for Water- 1st Work Station | 465 |
| On/Off Valve for Water- 2nd Work Station | 467 |
| On/Off Valve for Water- 3rd Work Station | 469 |
| On/Off Valve for Water- 4th Work Station | 471 |
| On/Off Valve for Water- 5th Work Station | 473 |
| On/Off Valve for Water- 6th Work Station | 475 |
| On/Off Valve for Water- 7th Work Station | 477 |
| Gas Feed for 1st Work Station | 485 |
| Gas Feed for 2nd Work Station | 487 |
| Gas Feed for 3rd Work Station | 489 |
| Gas Feed for 4th Work Station | 491 |
| Gas Feed for 5th Work Station | 493 |
| Gas Feed for 6th Work Station | 495 |
| Gas Feed for 7th Work Station | 497 |
| Water Outlet From 1st Work Station | 505 |
| Water Outlet From 2nd Work Station | 507 |
| Water Outlet From 3rd Work Station | 509 |
| Water Outlet From 4th Work Station | 511 |
| Water Outlet From 5th Work Station | 513 |
| Water Outlet From 6th Work Station | 515 |
| Water Outlet From 7th Work Station | 517 |
| Gas Outlet From 1st Work Station | 525 |
| Gas Outlet From 2nd Work Station | 527 |
| Gas Outlet From 3rd Work Station | 529 |
| Gas Outlet From 4th Work Station | 531 |
| Gas Outlet From 5th Work Station | 533 |
| Gas Outlet From 6th Work Station | 535 |
| Gas Outlet From 7th Work Station | 537 |
| Thermocouple Receiver for 1st Work Station | 545 |
| Thermocouple Receiver for 2nd Work Station | 547 |
| Thermocouple Receiver for 3rd Work Station | 549 |
| Thermocouple Receiver for 4th Work Station | 551 |
| Thermocouple Receiver for 5th Work Station | 553 |
| Thermocouple Receiver for 6th Work Station | 555 |
| Thermocouple Receiver for 7th Work Station | 557 |
| Clamp Rod Lock- 1st Work Station | 565 |
| Clamp Rod Lock- 2nd Work Station | 567 |
| Clamp Rod Lock- 3rd Work Station | 569 |
| Clamp Rod Lock- 4th Work Station | 571 |
| Clamp Rod Lock- 5th Work Station | 573 |
| Clamp Rod Lock- 6th Work Station | 575 |
| Clamp Rod Lock- 7th Work Station | 577 |
| In addition, FIG. 19 includes the following: | |
| Isolated Reaction Vessel Cover | 519 |
| Isolated Reaction Vessel Cover | 521 |
| Isolated Reaction Vessel Cover | 523 |
| Isolated Reaction Vessel Cover | 539 |
| Isolated Reaction Vessel Cover | 541 |
| Isolated Reaction Vessel Cover | 543 |
| Isolated Reaction Vessel Cover | 559 |

The water feeds may be used for coolant through a cofinger or other exchanger, and may be used in addition to a phase change coolant system or without a phase change coolant subsystem. The gas feeds may be used to provide inert blanket gas, cooling or heating gas or reaction gas, but is typically used to create an inert environment above reactants.

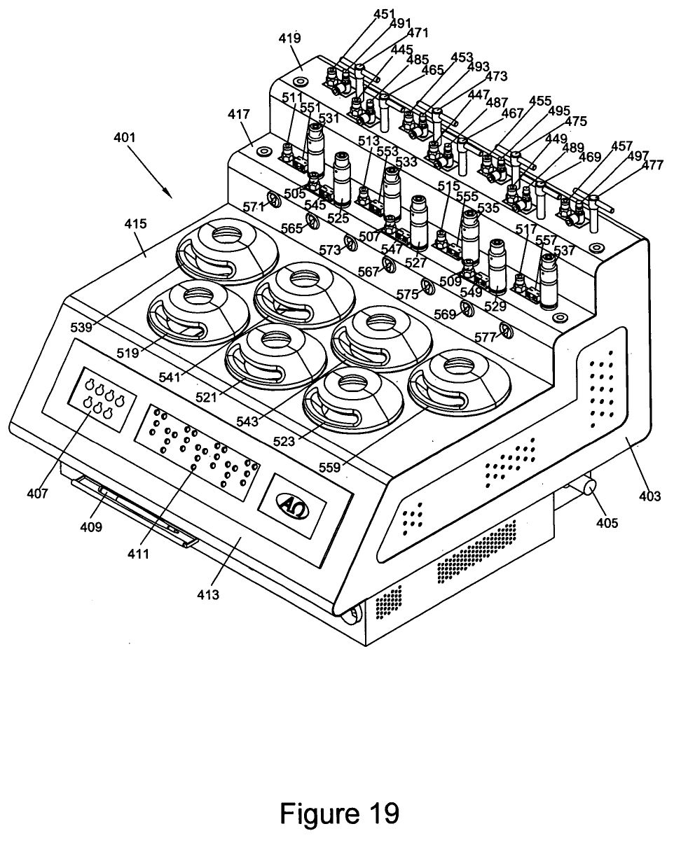

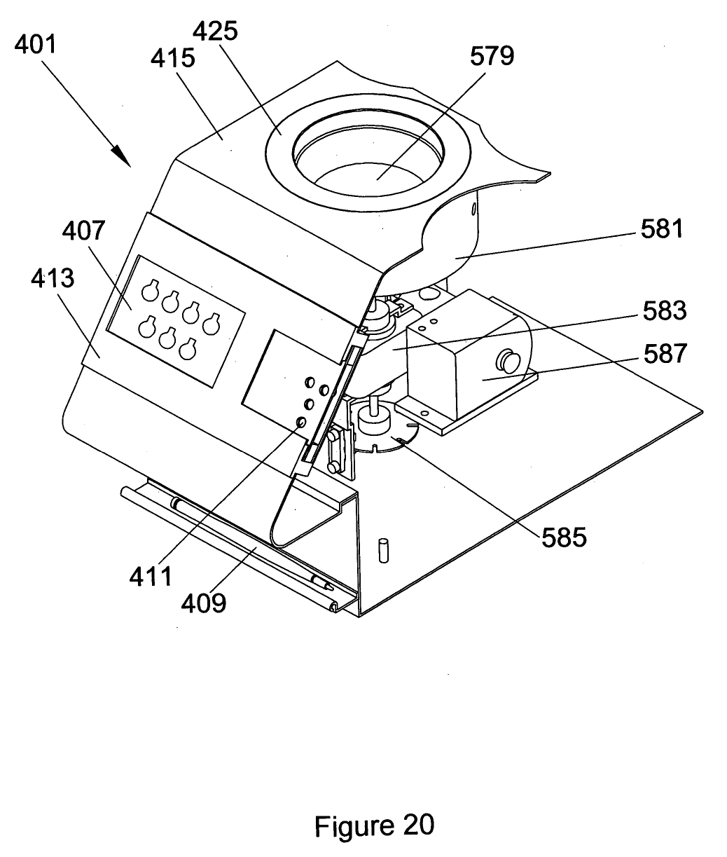

FIG. 20 shows a partial view of the same present invention instrument as shown in FIG. 18, but with additional features now included. These additional features include:

| | |
|---|---|
| Resistance Heater | 581 |
| Stirrer Magnet Motor | 583 |
| Timer Wheel | 585 |
| Controller | 587 |

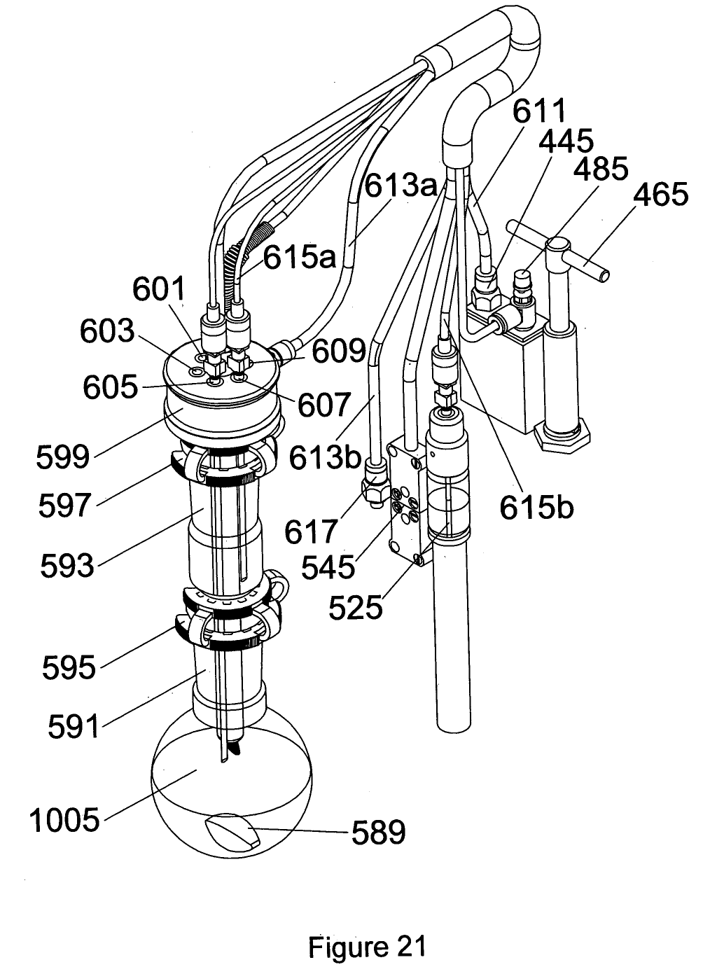

FIG. 21 illustrates a reaction vessel for a reflux type reaction with various functional connections and a cofinger stopper as may be used as a component of a present invention instrument, and includes the following additional components:

| | |
|---|---|
| Microreactor Reaction Vessel (1st) | 1005 |
| Magnetic Stirrer | 589 |
| Neck | 591 |
| Neck Extension | 593 |
| Lower Yoke | 595 |
| Upper Yoke | 597 |
| Cofinger Stopper | 599 |
| Stopper Port | 601 |
| Stopper Port | 603 |
| Stopper Port | 605 |
| Stopper Port | 607 |
| Stopper Port | 609 |
| 1st Reaction Vessel Water Inlet Line | 611 |
| 1st Reaction Vessel Water Outlet Line | 613a |
| 1st Reaction Vessel Water Outlet Line | 613b |
| 1st Reaction Vessel Gas Outlet Line | 615a |
| 1st Reaction Vessel Gas Outlet Line | 615b |
| Water Outlet Connector | 617 |
| Vessel Clamp | 619 |
| Vessel Clamp Securing Rod | 621 |
| Vessel Cover Half | 519a |
| Vessel Cover Half | 519b |
| Cofinger | 623 |
| Resistance Heater | 631 |
| Stirrer Magnet Motor | 633 |
| Timer Wheel | 635 |
| Controller | 637 |
| Vessel Clamp Securing Rod | 641 |
| Vessel Clamp | 643 |
| Cofinger Stopper | 645 |
| Stopper Port | 647 |
| Inert Gas Feed Line | 651 |
| Exhaust Gas Outlet Line | 653 |
| Bundle Elbow | 655 |
| Resistance Heater | 661 |
| Stirrer Magnet Motor | 663 |
| Timer Wheel | 665 |
| Controller | 667 |
| Vessel Clamp Securing Rod | 669 |
| Cofinger Stopper | 671 |
| Stopper Port | 673 |
| Thermocouple | 675 |
| Thermocouple Wire | 677 |
| Thermocouple Plug | 679 |
| Clamp | 681 |
| Resistance Heater | 691 |
| Stirrer Magnet Motor | 693 |
| Timer Wheel | 695 |
| Controller | 697 |
| Vessel Clamp Securing Rod | 699 |
| Clamp | 701 |
| Stopper | 703 |
| Stopper Port | 705 |
| Thermocouple Wire | 707 |
| Water Feed Line | 709 |
| Water Outlet Line and Stopper | 711a |
| Water Outlet Line | 711b |
| Exhausted Gas Outlet Line | 713a |
| Exhaust Gas Outlet Line | 713b |
| Bundle | 715 |
| Resistance Heater | 721 |
| Stirrer Magnet Motor | 723 |
| Timer Wheel | 725 |
| Controller | 727 |
| Vessel Clamp Securing Rod | 729 |
| Clamp | 731 |
| Stopper | 733 |
| Stopper Port | 735 |
| Thermocouple Wire | 737 |
| Inlet Gas Feed Line | 739 |
| Exhaust Gas Outlet Line | 741 |
| Bundle | 743 |
| Resistance Heater | 751 |
| Stirrer Magnet Motor | 753 |
| Timer Wheel | 755 |
| Controller | 757 |
| Vessel Clamp Securing Rod | 759 |
| Clamp | 761 |
| Stopper | 763 |
| Stopper Port | 765 |
| Vacuum Line | 967 |
| Vacuum Manifold | 969 |
| Vacuum Manifold Support | 951 |
| Inlet Gas Feed Line | 767 |
| Thermocouple | 769 |
| Resistance Heater | 771 |
| Stirrer Magnet Motor | 773 |
| Timer Wheel | 775 |
| Controller | 777 |
| Vessel Clamp Securing Rod | 779 |
| Clamp | 781 |
| Stopper | 783 |
| Stopper Port | 785 |
| Vacuum Line | 963 |
| Vacuum Control Valve | 965 |
| Vacuum Manifold | 961 |
| Vacuum Manifold Support | 951 |
| Vacuum Line Joint | 959 |
| Inlet Gas Feed Line | 787 |
| Vacuum Manifold Support | 951 |
| Vacuum Manifold Support Frame | 953 |
| Vacuum Manifold Support Upright | 955 |
| Vacuum Main Line | 957 |
| Vacuum Line Joint | 959 |
| Vacuum Manifold | 961 |
| Vacuum Line | 963 |
| Vacuum Control Valve | 965 |

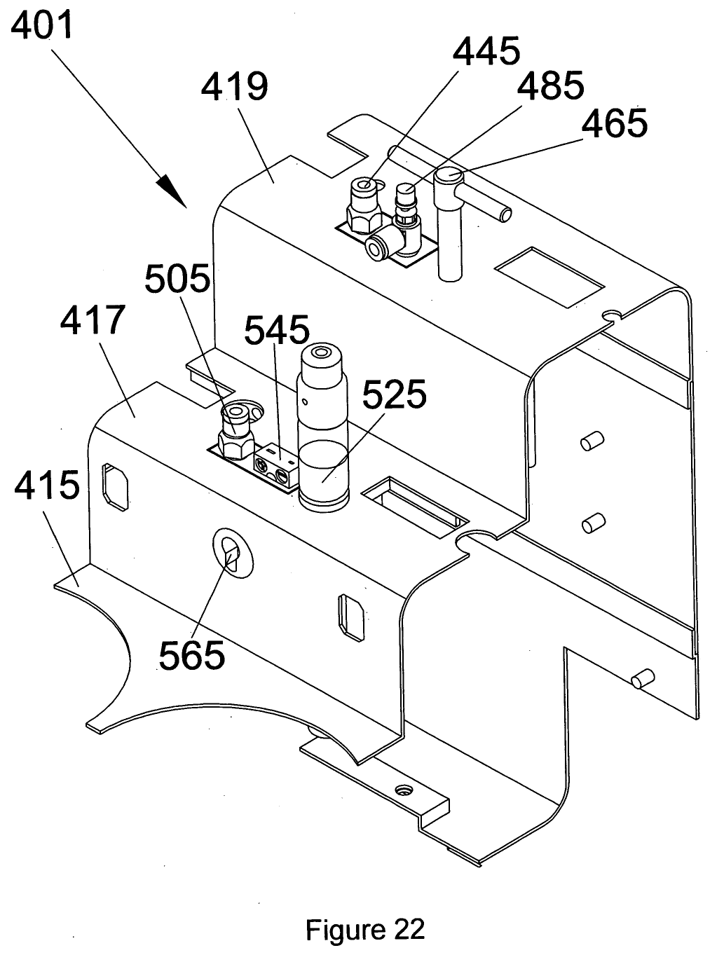

FIG. 22 shows a partial view of the same present invention instrument as shown in FIG. 18, but with additional features now included. Combined with FIG. 20, it is shown also in FIG. 23, with the vessel and components of FIG. 21 also included, in an exploded view;

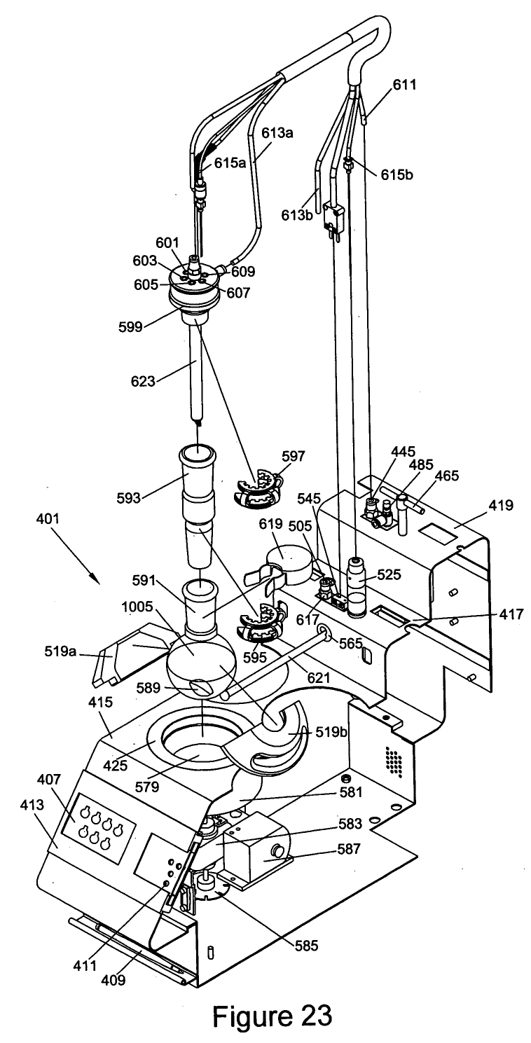

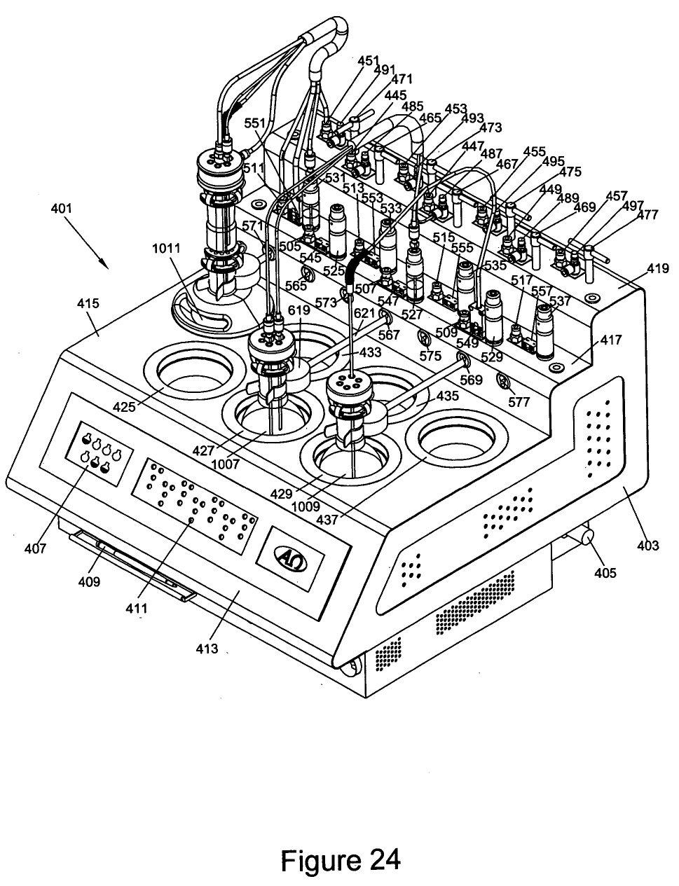

FIG. 24 shows an oblique view of the same present invention instrument as shown in FIG. 18, but with three reactor subsystems in place, one for a room temperature reaction under inert gas blanket, one for a room temperature reaction without a gas blanket, and one for a high temperature reaction;

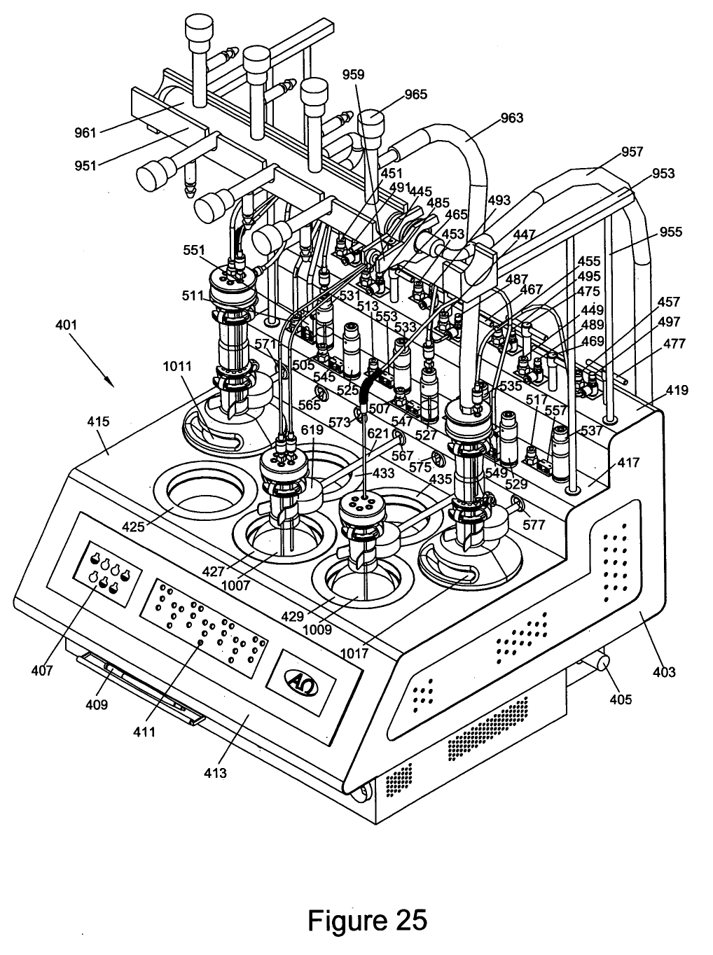

FIG. 25 is the same as FIG. 24, except that it now includes another reactor, this being for a solvent evaporation process;

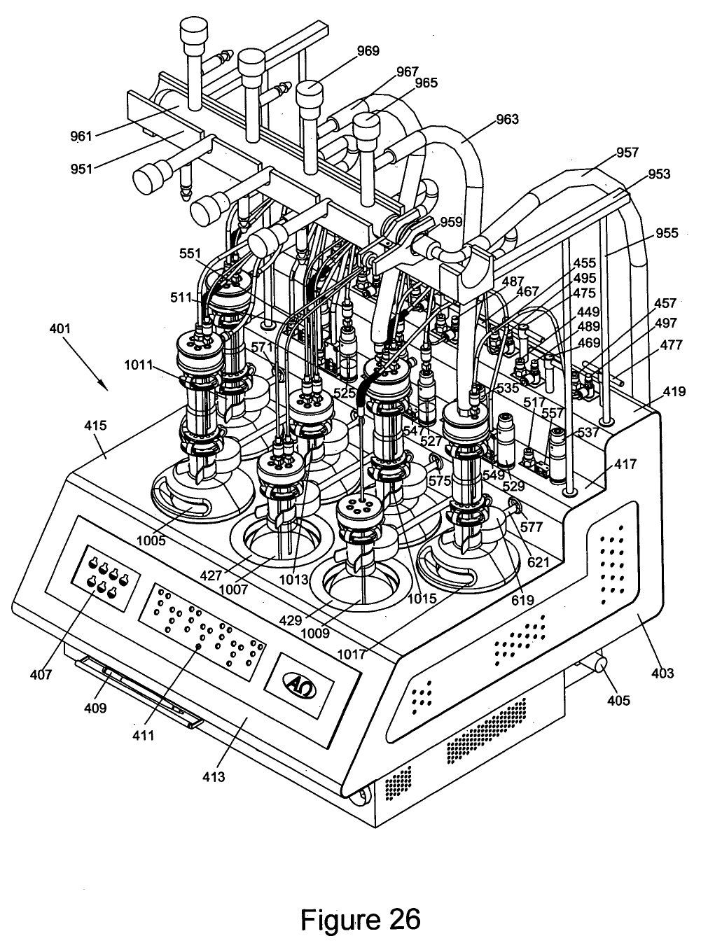

FIG. 26 is the same as FIG. 25, except that it now includes additional reactors, these being for a reflux reaction shown above, a below room temperature reaction under inert conditions, and a high temperature air sensitive reaction;

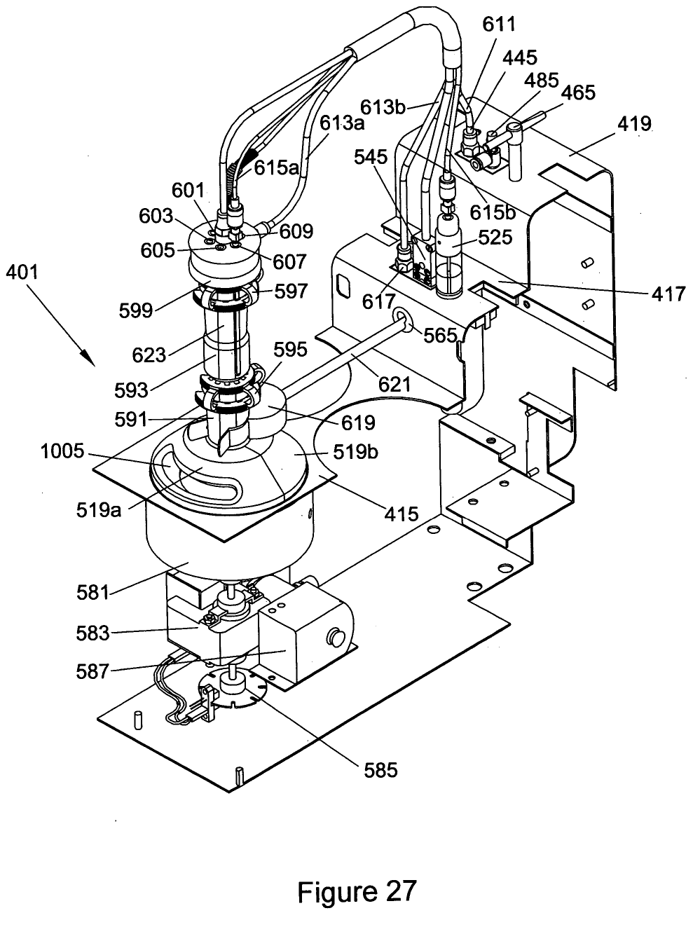

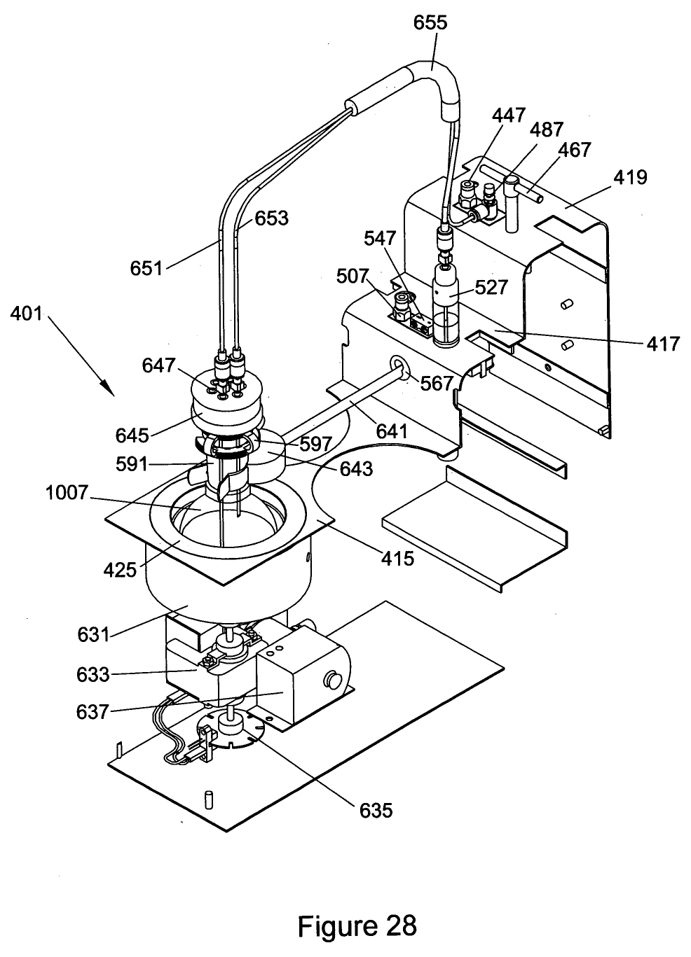

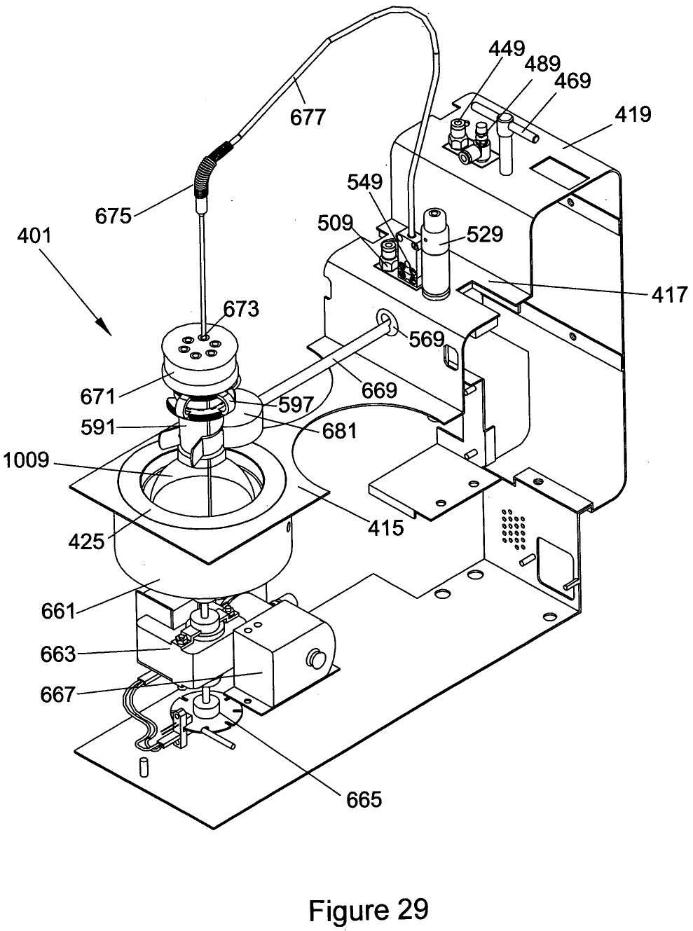

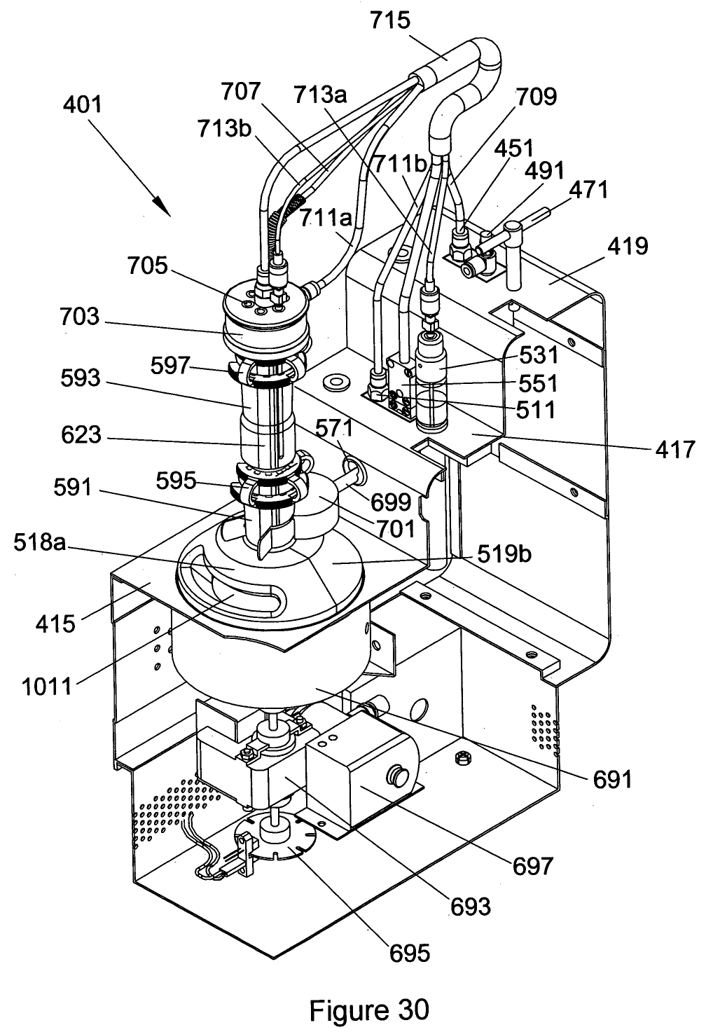

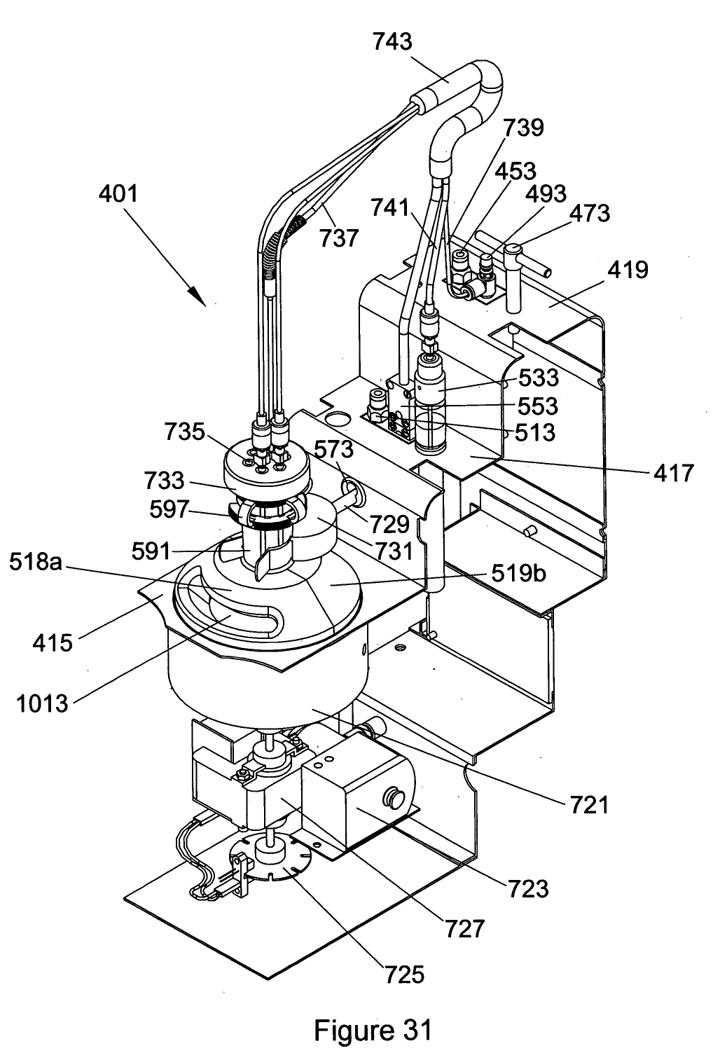

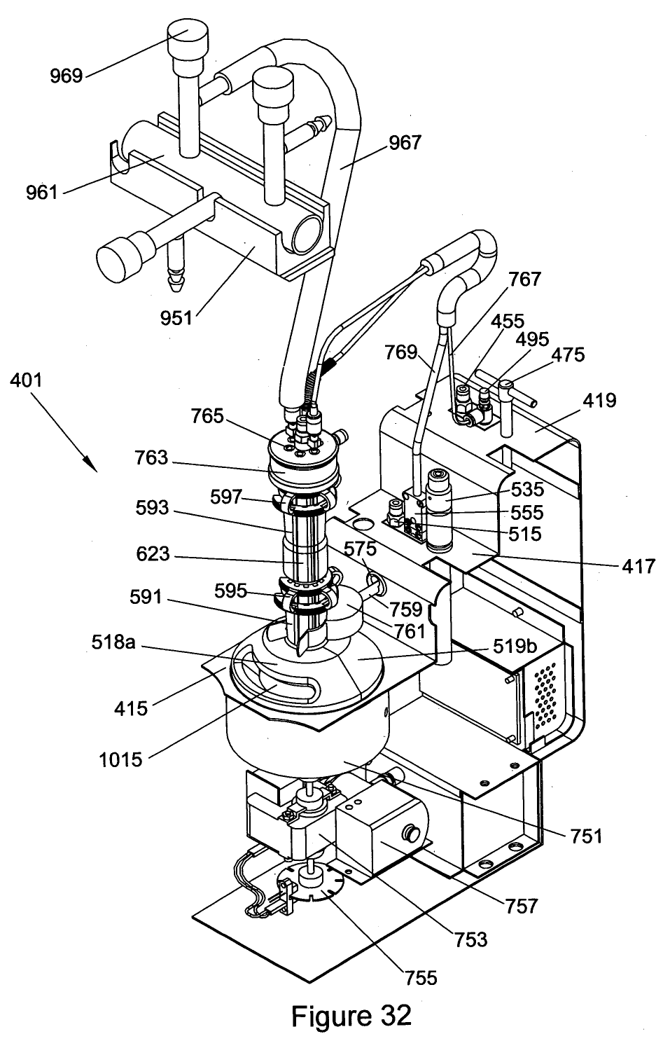

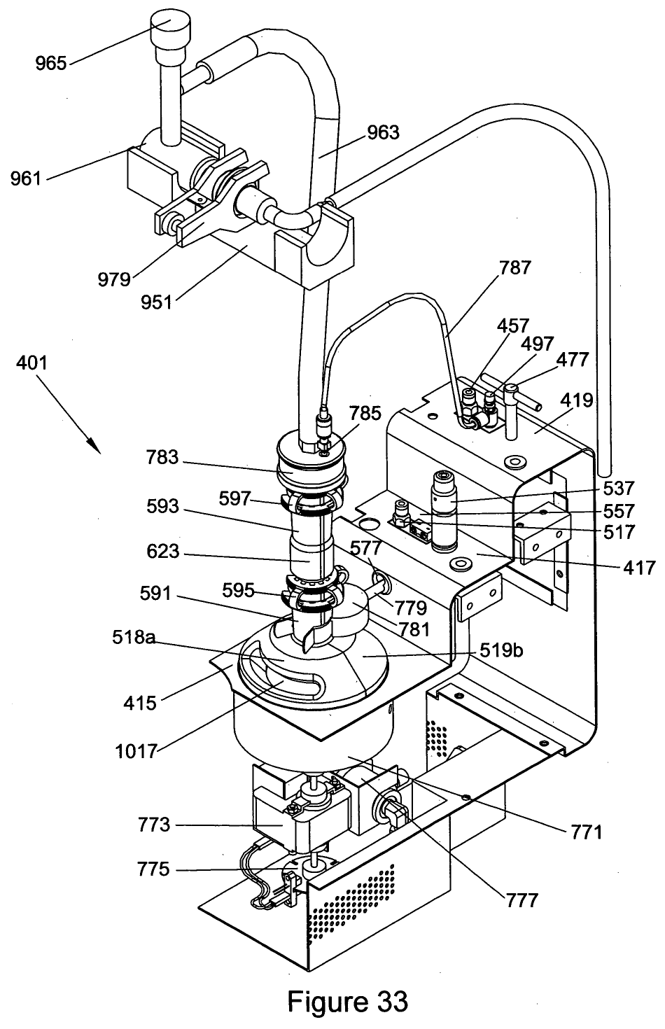

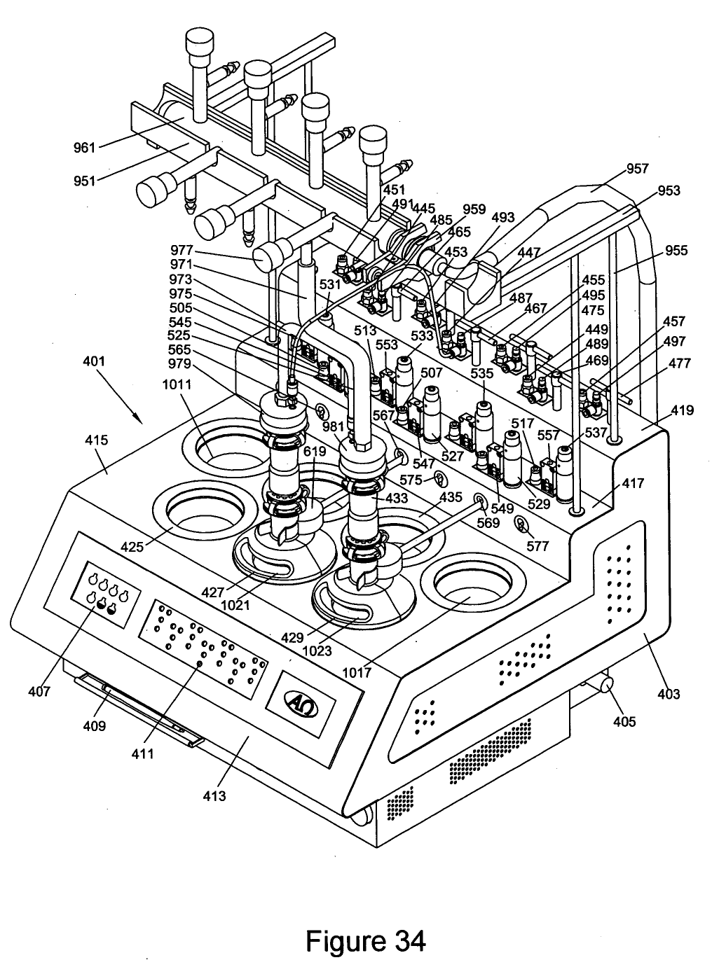

FIGS. 27, 28, 29, 30, 31, 32, and 33 illustrate various details of the different reactor arrangements in the previous Figures in partial, cut, enlarged views; and, FIG. 34 shows a present invention instruments with two reaction vessels that are interconnected for a single process with plural steps, occurring in the different reactors sequentially.

The components list for the foregoing Figures is as follows:

| | |
|---|---|
| Vessel Clamp | 619 |
| Vessel Clamp Securing Rod | 621 |
| Vessel Cover Half | 519a |
| Vessel Cover Half | 519b |
| Cofinger | 623 |
| Resistance Heater | 631 |
| Stirrer Magnet Motor | 633 |
| Timer Wheel | 635 |
| Controller | 637 |
| Vessel Clamp Securing Rod | 641 |
| Vessel Clamp | 643 |
| Cofinger Stopper | 645 |
| Stopper Port | 647 |
| Inert Gas Feed Line | 651 |
| Exhaust Gas Outlet Line | 653 |
| Bundle Elbow | 655 |
| Resistance Heater | 661 |
| Stirrer Magnet Motor | 663 |
| Timer Wheel | 665 |
| Controller | 667 |
| Vessel Clamp Securing Rod | 669 |
| Cofinger Stopper | 671 |
| Stopper Port | 673 |
| Thermocouple | 675 |
| Thermocouple Wire | 677 |
| Thermocouple Plug | 679 |
| Clamp | 681 |
| Resistance Heater | 691 |
| Stirrer Magnet Motor | 693 |
| Timer Wheel | 695 |
| Controller | 697 |
| Vessel Clamp Securing Rod | 699 |
| Clamp | 701 |
| Stopper | 703 |
| Stopper Port | 705 |
| Thermocouple Wire | 707 |
| Water Feed Line | 709 |
| Water Outlet Line and Stopper | 711a |
| Water Outlet Line | 711b |
| Exhausted Gas Outlet Line | 713a |
| Exhaust Gas Outlet Line | 713b |
| Bundle | 715 |
| Resistance Heater | 721 |
| Stirrer Magnet Motor | 723 |
| Timer Wheel | 725 |
| Controller | 727 |
| Vessel Clamp Securing Rod | 729 |
| Clamp | 731 |
| Stopper | 733 |
| Stopper Port | 735 |
| Thermocouple Wire | 737 |
| Inlet Gas Feed Line | 739 |
| Exhaust Gas Outlet Line | 741 |
| Bundle | 743 |
| Resistance Heater | 751 |
| Stirrer Magnet Motor | 753 |
| Timer Wheel | 755 |
| Controller | 757 |
| Vessel Clamp Securing Rod | 759 |
| Clamp | 761 |
| Stopper | 763 |
| Stopper Port | 765 |
| Vacuum Line | 967 |
| Vacuum Manifold | 969 |
| Vacuum Manifold Support | 951 |
| Inlet Gas Feed Line | 767 |
| Thermocouple | 769 |
| Resistance Heater | 771 |
| Stirrer Magnet Motor | 773 |
| Timer Wheel | 775 |
| Controller | 777 |
| Vessel Clamp Securing Rod | 779 |
| Clamp | 781 |
| Stopper | 783 |
| Stopper Port | 785 |
| Vacuum Line | 963 |
| Vacuum Control Valve | 965 |
| Vacuum Manifold | 961 |
| Vacuum Manifold Support | 951 |
| Vacuum Line Joint | 959 |
| Inlet Gas Feed Line | 787 |
| Vacuum Manifold Support | 951 |
| Vacuum Manifold Support Frame | 953 |
| Vacuum Manifold Support Upright | 955 |
| Vacuum Main Line | 957 |
| Vacuum Line Joint | 959 |
| Vacuum Manifold | 961 |
| Vacuum Line | 963 |
| Vacuum Control Valve | 965 |

As to FIG. 34, the reaction vessels 1021 and 1023 are arranged so as to be connected sequentially, for a two step process. The instrument 401 is the same as shown above. However, here there are two cofinger stoppers 979 and 981 working together, with a gas feed 975, a connector tube 973, a vacuum line 971 and a vacuum line control valve 977. This enables a user to perform different steps in different reactors to perform multistep reactions with the present invention instrument. It should now be seen that more than two reactors could be interconnected in this fashion.

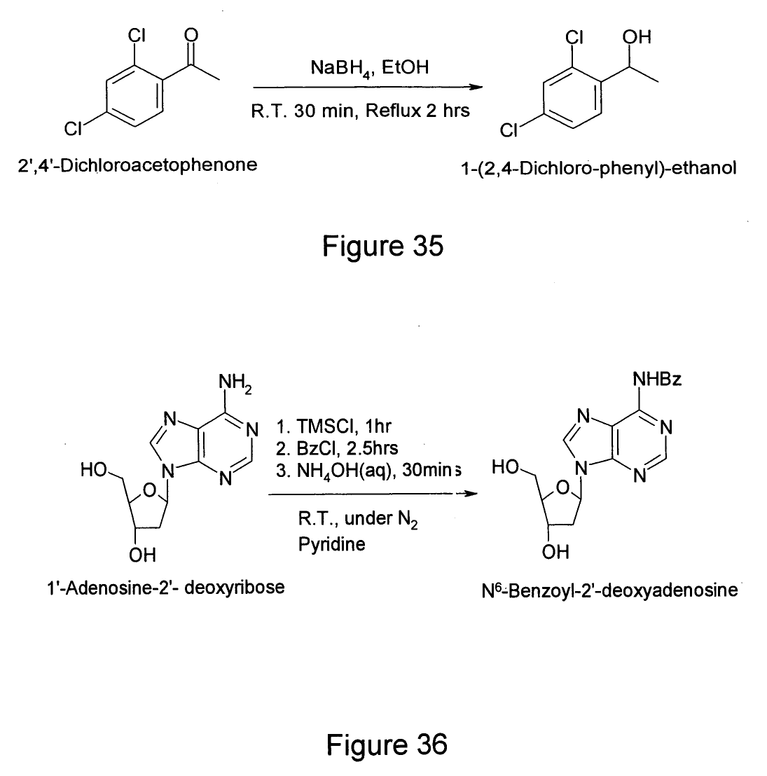

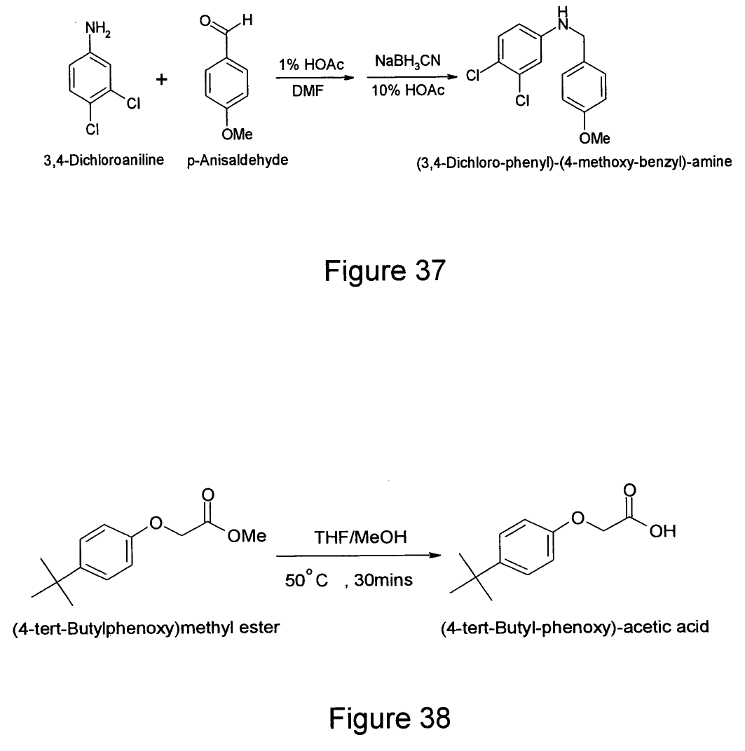

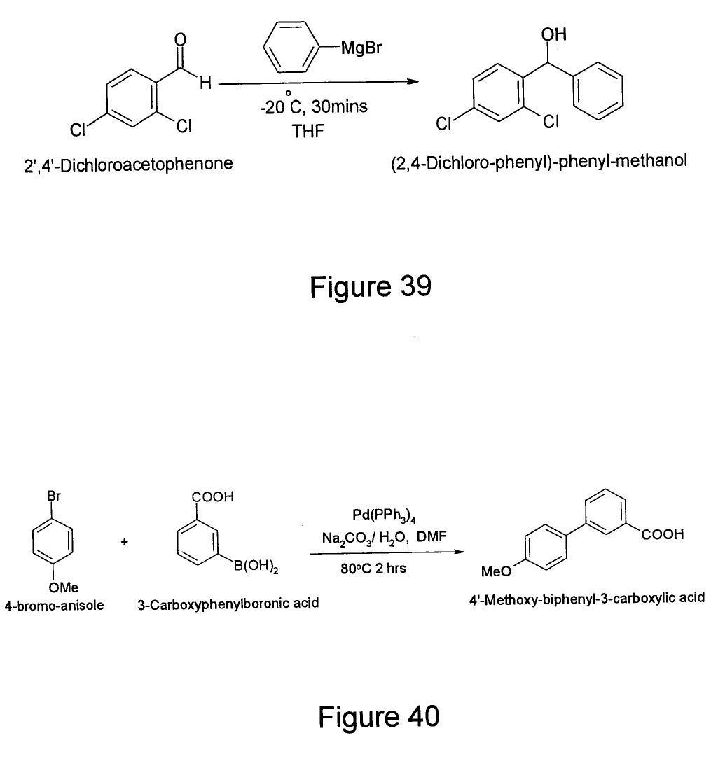

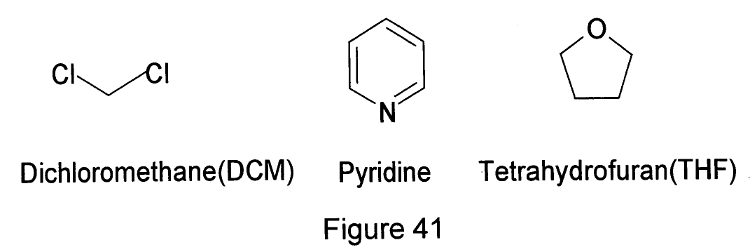

As mentioned above, many types of reactions and processes may be preformed simultaneously, yet independently utilizing present invention instruments. The following Table I shows examples of set-ups for specific reaction vessels and corresponding examples of the types of reactions that may be performed. Actual reactions are shown in FIGS. 35 through 42.

TABLE I

| REACTOR | SHOWN | EXAMPLE |
|---|---|---|
| VESSEL | IN | PROCESS |
| NUMBER | FIG. | FIG. |
| 1005 | 27 | 35 |
| 1007 | 28 | 36 |
| 1009 | 29 | 37 |
| 1011 | 30 | 38 |
| 1013 | 31 | 39 |
| 1015 | 32 | 40 |
| 1017 | 33 | 41 |

Obviously, numerous modifications and variations of the present invention are possible in light of the above teachings. It is therefore understood that within the scope of the appended claims, the invention may be practiced otherwise than as specifically described herein.

1. A multifunctional multireactor chemical synthesis instrument, which comprises:
(a.) a main housing having at least three independent work stations, each work station adapted to receive a reaction vessel;
(b.) at least one cooling unit finctionally connected to each of said at least three independent work stations to impart controlled cooling thereto, each said cooling unit including:
(i.) a cooling element in proximity to each of said at least three independent work stations and having an inlet port for injection of a phase change coolant, a heat absorbent area and an outlet port for removal of said phase change coolant; and,
(ii.) injection means for injecting said phase change coolant in liquid form via said inlet port to said cooling element;
(c.) at least one heating unit functionally connected to each of said at least three independent work stations to impart controlled heating thereto;
(d.) at least one stirring mechanism connected to each of said at least three independent work stations;
(e.) control means connected to each cooling unit and each heating unit and to each stirring mechanism, for programmable automatic control of said injection means to separately control at least one of on/off flow and rate of flow, to separately control at least one of on/off heating and rate of heating, and to separately control each stirring mechanism, said control means including a programmable device;
wherein said control means includes software, and said system includes an injection means, physical control device, for cyclical on/off control thereof to establish at least one predetermined temperature sequence involving a plurality of diverse, programmable temperature levels.

2. The instrument of claim 1 which further includes a remote reservoir of said phase change coolant connected to each of said injection means and inlet ports, wherein said reservoir contains a phase change coolant in a liquid state under pressure.

3. The instrument of claim 2 wherein said phase change coolant is an environmentally inert material which absorbs heat upon vaporization and has a boiling point below room temperature at atmospheric pressure.

4. The instrument of claim 3 wherein said phase change coolant is selected from the group consisting of inert gases, carbon dioxide and nitrogen.

5. The instrument of claim 1 which further includes:
(f.) at least one reflux mechanism for each of said independent work stations.
g.) at least one inert gas blanket mechanism for each of said independent work stations.

6. The instrument of claim 1 wherein each of said independent work stations includes means for evaporation functions and means for vacuum pressure functions for a reactor vessel.

7. The instrument of claim 1 wherein each of said independent work stations are recessed with an upper portion and a lower portion, and each cooling unit is connected to its work station at its upper portion, and each cooling unit includes:
(i) a cooling element in proximity to said upper portion of said vessel and having an inlet port for injection of a phase change coolant, a heat absorbent area, and an outlet port for removal of said phase change coolant;
(ii) injection means connected to said inlet port, adapted for programmable, controlled injection of a phase change coolant into said cooling element; and,
(iii) a phase change coolant source connected to said injection means and containing a phase change coolant in a liquid state under pressure; and each heating unit is connected to its work station at its lower portion and adapted to programmably and controllably impart heat.

8. The instrument of claim 1 wherein said control means includes preprogrammable capability independently for each work station, for presetting a plurality of desired temperature settings and desired times corresponding to said desired temperature settings, at least one temperature sensor functionally connectable to a reactor vessel, and sufficient software to recognize temperature from said vessel and to respond thereto by controlling the operation of said heating unit and said cooling unit to achieve said desired temperature settings and desired times within predetermined acceptable ranges of deviation.

9. The instrument of claim 1 wherein said control unit is located within said main housing and said main housing includes an input mechanism connected to said control unit programmable device.

10. The instrument of claim 9 wherein said main housing includes independent on/off indicators for a plurality of functions for each work station.

11. A multifunctional multireactor chemical synthesis instrument, which comprises:
(a.) a main housing having at least three independent work stations, each work station adapted to receive a reactor vessel;
(b.) at least one cooling unit functionally connected to each of said at least three independent work stations to impart controlled cooling thereto, each said cooling unit including:
(iii.) a cooling element in proximity to each of said at least three independent work stations and having an inlet port for injection of a coolant, a heat absorbent area and an outlet port for removal of said coolant; and,
(iii.) injection means for injecting said coolant in liquid form via said inlet port to said cooling element;
(c.) at least one heating unit functionally connected to each of said at least three independent work stations to impart controlled heating thereto;
(d.) at least one stirring mechanism connected to each of said at least three independent work stations;
(e.) at least one of said work stations having a microreactor reaction vessel contained therein, said reaction vessel having an cylindrical open neck and a hollow containment area of predetermined volume for conducting a chemical process;
(f.) a multiport cofinger stopper functionally connected to said reaction vessel open neck, said multiport cofinger having:
(i.) a main housing, said main housing having a top and a bottom, and sidewalls, and having a central orifice passing from said top to said bottom, said central orifice being located toward a center of said top, said central orifice including a cofinger, and having a plurality of outer orifices located about said central orifice, each passing from said top to said bottom;
(ii.) sealing means on said sidewalls of said main housing for sealably connecting said stopper to said reaction vessel open neck.
(g.) control means connected to each cooling unit and each heating unit and to each stirring mechanism, for programmable automatic control of said injection means to separately control at least one of on/off flow and rate of flow, to separately control at least one of on/off heating and rate of heating, and to separately control each stirring mechanism, said control means including a programmable device;
wherein said control means includes software, and said system includes an injection means, physical control device, for cyclical on/off control thereof to establish at least one predetermined temperature sequence involving a plurality of diverse, programmable temperature levels.

12. The instrument of claim 11 wherein said cofinger is a concentric set of at least two tubes, each of said tubes having an upper end and lower end, wherein each of said tubes is open-ended at its lower end and each of said tubes is functionally connected to said instrument at its upper end.

13. The instrument of claim 11 wherein said cofinger is a concentric set of two tubes, each of said tubes having an upper end and a lower end, wherein there is an inside tube having an open lower end and a outside tube surrounding said inside tube, said outside tube having a closed lower end.

14. The instrument of claim 11 which further includes a remote reservoir of said phase change coolant connected to each of said injection means and inlet ports, wherein said reservoir contains a phase change coolant in a liquid state under pressure.

15. The instrument of claim 14 wherein said phase change coolant is an environmentally inert material which absorbs heat upon vaporization and has a boiling point below room temperature at atmospheric pressure.

16. The instrument of claim 15 wherein said phase change coolant is selected from the group consisting of inert gases, carbon dioxide and nitrogen.

17. The instrument of claim 11 which further includes:
(g.) at least one reflux mechanism for each of said independent work stations.
(h.) at least one inert gas blanket mechanism for each of said independent work stations.

18. The instrument of claim 11 wherein each of said independent work stations includes means for evaporation functions and means for vacuum pressure functions for a reactor vessel.

19. The instrument of claim 11 wherein each of said independent work stations are recessed with an upper portion and a lower portion, and each cooling unit is connected to its work station at its upper portion, and each cooling unit includes:
(i) a cooling element in proximity to said upper portion of said vessel and having an inlet port for injection of a phase change coolant, a heat absorbent area, and an outlet port for removal of said phase change coolant;
(ii) injection means connected to said inlet port, adapted for programmable, controlled injection of a phase change coolant into said cooling element; and,
(iii) a phase change coolant source connected to said injection means and containing a phase change coolant in a liquid state under pressure;
and each heating unit is connected to its work station at its lower portion and adapted to programmably and controllably impart heat.

20. The instrument of claim 11 wherein said control means includes preprogrammable capability independently for each work station, for presetting a plurality of desired temperature settings and desired times corresponding to said desired temperature settings, at least one temperature sensor functionally connected to said vessel, and sufficient software to recognize temperature from said vessel and to respond thereto by controlling the operation of said heating unit and said cooling unit to achieve said desired temperature settings and desired times within predetermined acceptable ranges of deviation.
